(19) United States
(12) Patent Application Publication
(10) Pub. No.: US 2006/0010012 A1
(43) Pub. Date: Jan. 12, 2006

(54) Portable medical information device

(76) Inventors: Carl Franzblau, Newton, MA (US); Jay Kaplan, Harrington Park, NJ (US)

Correspondence Address: NIELDS & LEMACK, 176 EAST MAIN STREET, SUITE 7, WESTBORO, MA, 01581, US

(21) Appl. No.: 11/104,222

(22) Filed: Apr. 12, 2005

Related U.S. Application Data
(60) Provisional application No. 60/567,345, filed on Apr. 29, 2004.

(51) Int. Cl. G06Q 10/00

(52) U.S. Cl. 705/2

(57) ABSTRACT

The present invention provides a system and method of providing personal and medical information in a portable manner. The present invention also allows the user to easily update and modify the information contained in the device. Briefly, a storage element, preferably having a standard computer interface, most preferably a USB port, is disclosed. Sets of data structures that allow the user to incorporate information about their medical history and profile are provided on the storage element. The data structures also allow the user to enter images, such as jpeg, tiff or bitmap files, to further augment their history. These data structure also allow the health care provider to quickly and easily access the relevant information in a timely and organized manner. The storage element also contains the required software application needed to view the data structures.

This application claims priority of U.S. Provisional Application Ser. No. 60/567,345, filed Apr. 29, 2004, the disclosure of which is incorporated herein by reference.

### BACKGROUND OF THE INVENTION

Every person has his own unique medical profile and history. This medical profile and history is relevant and typically used by the person's physician or care provider, in conjunction with a physical exam, to diagnose and treat the patient. While a patient's medical records are generally accessible when the patient is with their primary care provider, it is less accessible in other scenarios. For example, most people do not carry their medical records with them when they travel on vacation, or even when they visit friends or families in nearby areas. Similarly, medical records are typically not immediately available in emergency situations, when the patient has been seriously hurt, or has fallen sick and requires immediate medical attention, and is taken to a hospital. Additionally, medical records are often not available when the patient visits other physicians who are not his primary care provider, such as specialists.

Different mechanisms have been devised to address this issue to varying degrees. For example, bracelets and necklaces have traditionally been used to identify individuals with serious medical conditions or allergies, such as diabetes, asthma, epilepsy, and allergies to such substances as penicillin, peanuts, dairy, nuts and other foods. These bracelets are able to inform an emergency care provider of special needs and issues associated with the patient, even when the person is unable to communicate these himself for some reason, such as unconsciousness or language barriers.

Typically, these bracelets and necklaces have limited space on which to describe the specific medical condition of the wearer. Therefore, while they are effective in pointing out a particular condition, such as diabetes, they are ineffective at providing a complete medical history of the wearer. Others have tried to overcome this shortcoming using a number of different mechanisms.

For example, U.S. Pat. No. 4,197,665 describes a locket that includes a magnifying lens with personal and medical information written in substantially reduced form, held inside the locket. More information can be provided by reducing the size of the text and providing the user with a magnifying lens with which to view it.

U.S. Pat. No. 5,359,798 describes a pendant that includes a piece of microfilm and a lens adapted to focus on the microfilm. As with the '665 patent, this mechanism allows more information to be contained in the limited space provided by a pendant or locket.

U.S. Pat. No. 5,877,742 describes a bracelet that contains an electronic memory element. Using infrared technology, a programming station can load up to 16k bits of personal and medical history into the memory. Upon actuation of a button on the bracelet, a LCD display scrolls the data stored in the bracelet so that it is readable.

U.S. Pat. No. 6,419,158 describes a locket that contains an electronic memory device. The contents of this memory device are accessible by placing a portion of the memory device inside a specially designed reader.

Each of these patents recognizes the inherent shortcomings in the traditional bracelet or necklace with regard to the amount of information that can be stored. Each employs some mechanism to allow more information to be stored in the limited space available.

While each of these patents provides more information than is traditionally available, none of them allows all of the person's medical and personal history to be stored. For example, an individual may have an assortment of ailments, and associated medications. Even with 16k bits of memory, it may not be possible to store all of the relevant information about that person. As a result, the patient must predetermine what medical information is to be stored in the limited space available, and generally chooses that information which is most likely to be needed in an emergency situation. However, depending upon the nature of the emergency, information that was previously deemed unimportant might become critical. Furthermore, the medical information that is provided is not standardized and is not available in a consistent manner. In some embodiments, a magnifying lens is used, while in others a special reader is needed.

Additionally, many patients' medical history includes graphs, such as EKGs, dental records or X-Rays, which cannot be easily translated to text format. For example, a person with a known heart arrhythmia may wish to keep a copy of his EKG with him to ensure that doctors are aware of this issue, and do not diagnose this as a new problem, and treat the patient accordingly. Secondly, the prior EKG or other graph is important to use as a comparison baseline for comparative purposes.

Furthermore, conventional devices do not provide the user with an easy method of updating or changing their medical information. For example, as new conditions develop, a user cannot generate a microfilm or new memory chip without the aid of special tools and instrumentation. Even were these tools and instrumentation readily available, they require extensive knowledge to use properly.

Lastly, each of these devices is designed to store information specific to the person wearing the device. The ability to store medical information not only specific to the person wearing the device, but also about that person's spouse, children, and/or travel companions would be beneficial.

It is therefore an object of the present invention to provide a system and method of providing portable personal and medical information, which contains all of the individual's medical data and profile, in a manner that is easily accessible by the care provider without the use of specialized equipment.

It is a further object of the present invention to provide a mechanism and system whereby the information can be easily updated and modified by the user.

It is a still further object of the present invention to provide a system and method that includes access to non-text-based information, such as X-Rays, dental records, charts and pictures.

### SUMMARY OF THE INVENTION

The problems of the prior art have been overcome by the present invention, which provides a system and method of providing personal and medical information in a portable manner. The present invention also allows the user to easily update and modify the information contained in the device. Briefly, a storage element, preferably having a standard computer interface, most preferably a USB port, is disclosed. Sets of data structures that allow the user to incorporate information about their medical history and profile are provided on the storage element. The data structures also allow the user to enter images, such as jpeg, tiff or bitmap files, to further augment their history. These data structure also allow the health care provider to quickly and easily access the relevant information in a timely and organized manner. The storage element also contains the required software application needed to view the data structures.

### BRIEF DESCRIPTION OF THE DRAWINGS

FIGS. 1 and 1a are two alternate graphical representations of the “Welcome” field as viewed on a computer screen for the present invention;

FIGS. 2 and 2a are two alternate graphical representations of the “Table of Contents” field as viewed on a computer screen for the present invention;

FIGS. 3 and 3a are two alternate graphical representations of the “Medical Profile” field as viewed on a computer screen for the present invention;

FIGS. 4 and 4a are two alternate graphical representations of the “Patient Personal Information” field as view on a computer screen for the present invention;

FIGS. 5 and 5a are two alternate graphical representations of the “Medical Conditions” field as viewed on a computer screen for the present invention;

FIGS. 6 and 6a are two alternate graphical representations of the “Medical Conditions—Additional Information” field as viewed on a computer screen for the present invention;

FIGS. 7 and 7a are two alternate graphical representations of the “Allergies” field as viewed on a computer screen for the present invention;

FIGS. 8 and 8a are two alternate graphical representations of the “Drug Allergies” field as viewed on a computer screen for the present invention;

FIGS. 9 and 9a are two alternate graphical representations of the “Immunizations” field as viewed on a computer screen for the present invention;

FIGS. 10 and 10a are two alternate graphical representations of the “Prostheses/Dental/Eye/Surgical Procedures” field as viewed on a computer screen for the present invention;

FIGS. 11 and 11a are two alternate graphical representations of the “Other Hospitalizations” field as viewed on a computer screen for the present invention;

FIGS. 12 and 12a are two alternate graphical representations of the “Doctors” field as viewed on a computer screen for the present invention;

FIGS. 13 and 13a are two alternate graphical representations of the “Medications & Dosages” field as viewed on a computer screen for the present invention;

FIGS. 14 and 14a are two alternate graphical representations of the “EKG” field as viewed on a computer screen for the present invention;

FIGS. 15 and 15a are two alternate graphical representations of the “Other Scanned Document” field as viewed on a computer screen for the present invention;

FIGS. 16 and 16a are two alternate graphical representations of the “Additional Scans” field as viewed on a computer screen for the present invention;

FIGS. 17 and 17a are two alternate graphical representations of the “Laboratory Reports” field as viewed on a computer screen for the present invention;

FIGS. 18 and 18a are two alternate graphical representations of the “Additional Lab Reports” field as viewed on a computer screen for the present invention;

FIGS. 19 and 19a are two alternate graphical representations of the “Family History” field as viewed on a computer screen for the present invention;

FIGS. 20 and 20a are two alternate graphical representations of the second “Family History” field as viewed on a computer screen for the present invention;

FIGS. 21 and 21a are two alternate graphical representations of the “Doctor's Notes” field as viewed on a computer screen for the present invention;

FIGS. 22 and 22a are two alternate graphical representations of the second “Doctor's Notes” field as viewed on a computer screen for the present invention; and

FIGS. 23 and 23a are two alternate graphical representations of the “Nurse's Notes” field as viewed on a computer screen for the present invention.

FIG. 24 is an embodiment of the memory device used to store the medical history in the active position;

FIG. 25 is an embodiment of the memory device used to store the medical history in the inactive position;

FIG. 26 is a graphical representation of the “Patient's Notes” field as viewed on a computer screen for the present invention; and

FIG. 27 is a graphical representation of the “Emergency Information” field as viewed on a computer screen for the present invention.

### DETAILED DESCRIPTION OF THE INVENTION

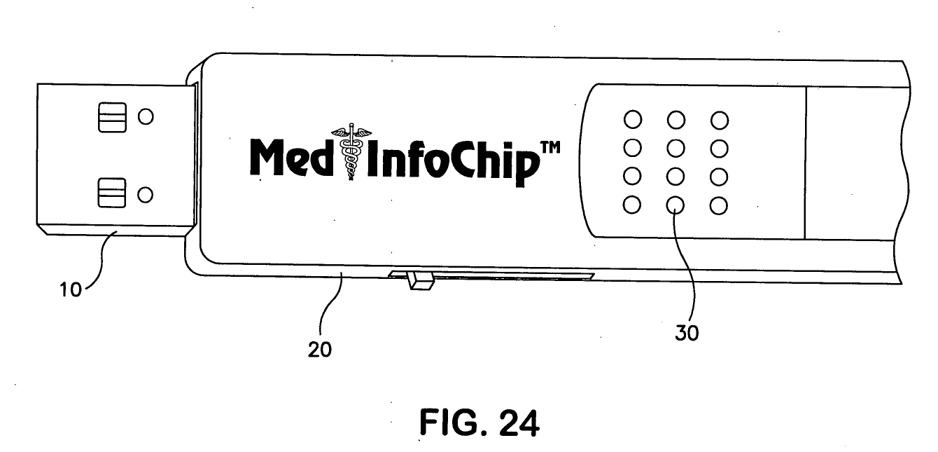

Turning first to FIG. 24, there is shown one embodiment of the memory device of the present invention. Connector 10 is extended from housing 20 by actuation of sliding member 30 in the direction of the connector. Similarly, connector 10 is enclosed within housing 20 by actuation of sliding member 30 in the opposite direction.

Connector 10 in the preferred embodiment is a USB connector, capable of installation into any computing device having a USB port, such as a personal computer, or handheld computing device. While USB is the preferred implementation, the invention is not limited to only this interface. Other interfaces, such as firewire, 1394, serial port, parallel port and smartcard, are within the scope of the invention. Similarly, the interface does not need to have a physical connection. Infrared, Bluetooth™ and other wireless protocols are also within the scope of the invention.

Returning to FIG. 24, connector 10 is in communication with a storage element (not shown) contained within the housing 20. This storage element is preferably a FLASH memory, capable of retaining data in the absence of power, and with the ability to be written multiple times. The capacity of this storage element is a function of the specific implementation, and is preferably at least 16 megabytes.

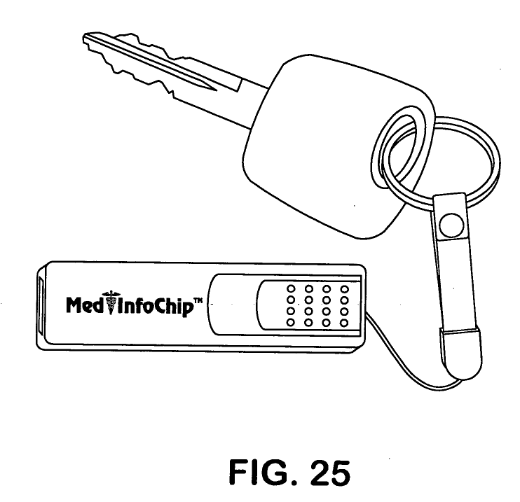

The device is preferably configured in a form that allows it to be conveniently carried, worn by or affixed to a person. FIG. 25 illustrates the device attached to a key chain for convenience. Alternatively, the device can be attached to a lanyard and worn around the neck, wrist or ankle, or could be carried in a wallet, purse or pocketbook. Alternatively still, the device can be configured to attach to various articles of clothing, including attachment to belt loops, shoes, shoelaces, zippers and buttons. The device could also be worn as jewelry, including watches, earrings, bracelets and necklaces.

Other physical embodiments of the device are within the scope of the present invention. For example, the storage device and connector may be formed in the shape of a credit card, which can be carried in a wallet or purse. Such an embodiment offers another convenient method of carrying the device. The USB connector for a device in the shape of a credit card may be slidingly engaged, as shown in FIG. 24. Alternatively, it may be connected to the credit card via a short wire.

Similarly, USB storage elements can be embedded in wristwatches and pens, both of which are commercially available. These and other embodiments are all within the scope of the invention and offer other convenient mechanisms of carrying medical history.

In addition to the physical device, the present invention includes the software and data structures that allow a traditional storage element to function as a portable medical information device.

Embedded in the storage element of the device are the software and data structures that allow the user to enter their medical history in a simple, organized, easy to use manner. By embedding the software and data structures within the storage element of the device, it is possible to utilize the present invention with any personal computer, without the need to load any special or specific software or software applications on that computer. Thus, the information stored on the device is readily accessible to any person, such as emergency medical personnel, emergency room physicians, hospital personnel, and other health care providers, with access to a personal computer.

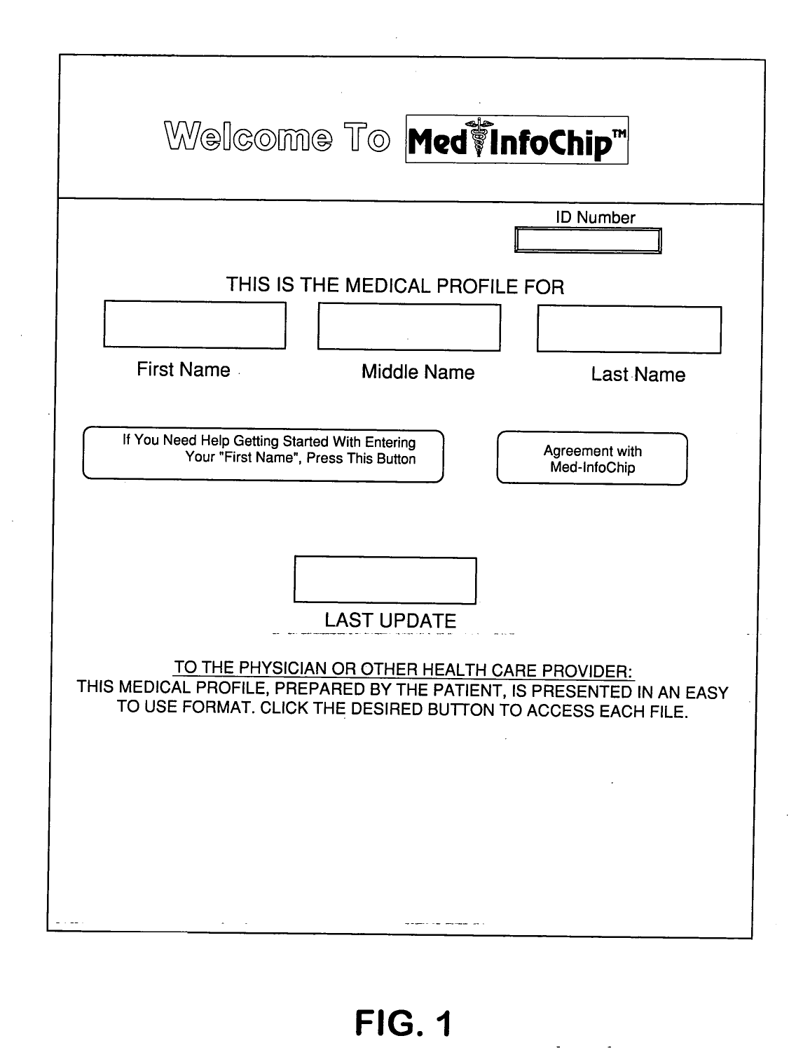

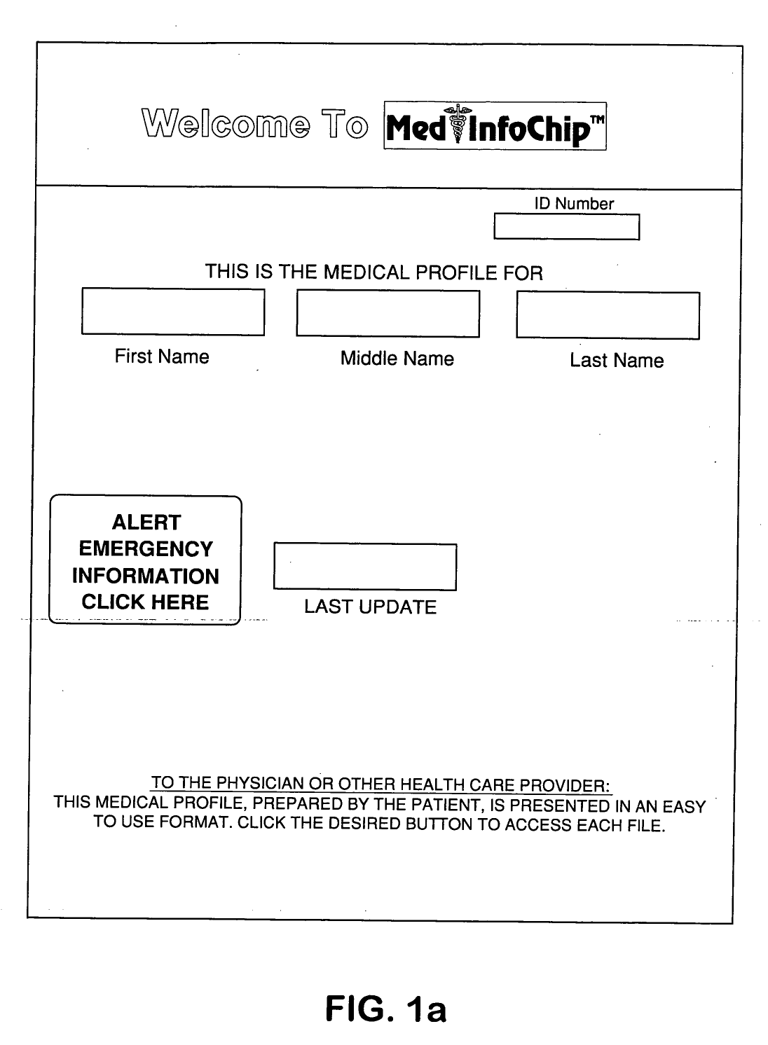

Referring to FIGS. 1 and 1a, alternate embodiments of a “Welcome” field are shown, where the user inputs their first, middle and last names. The application saves this information such that it need be entered only once. The application also saves the date of the last update in the corresponding field. FIG. 1a also illustrates a link to the “Emergency Information” field. By “clicking” the mouse over this area of the screen, the application will go immediately and directly to that field. The “Emergency Information” field, which is described later, contains that information which is considered to be most critical to the diagnosis and treatment of a patient in an emergency situation.

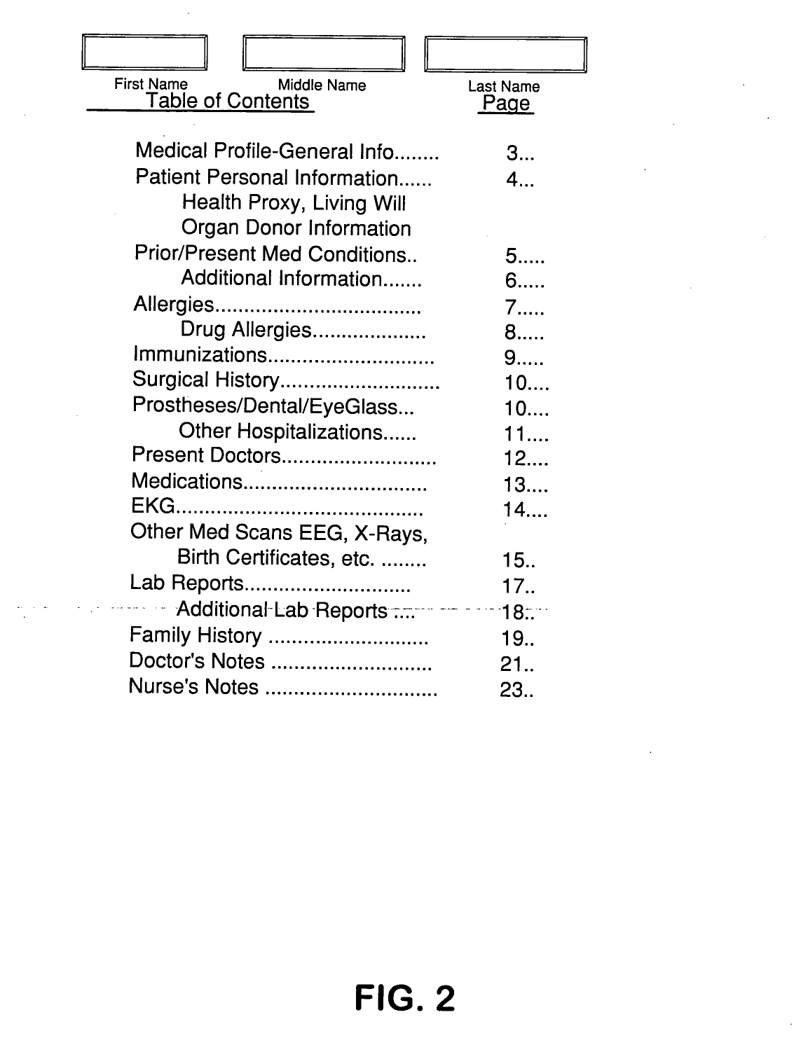

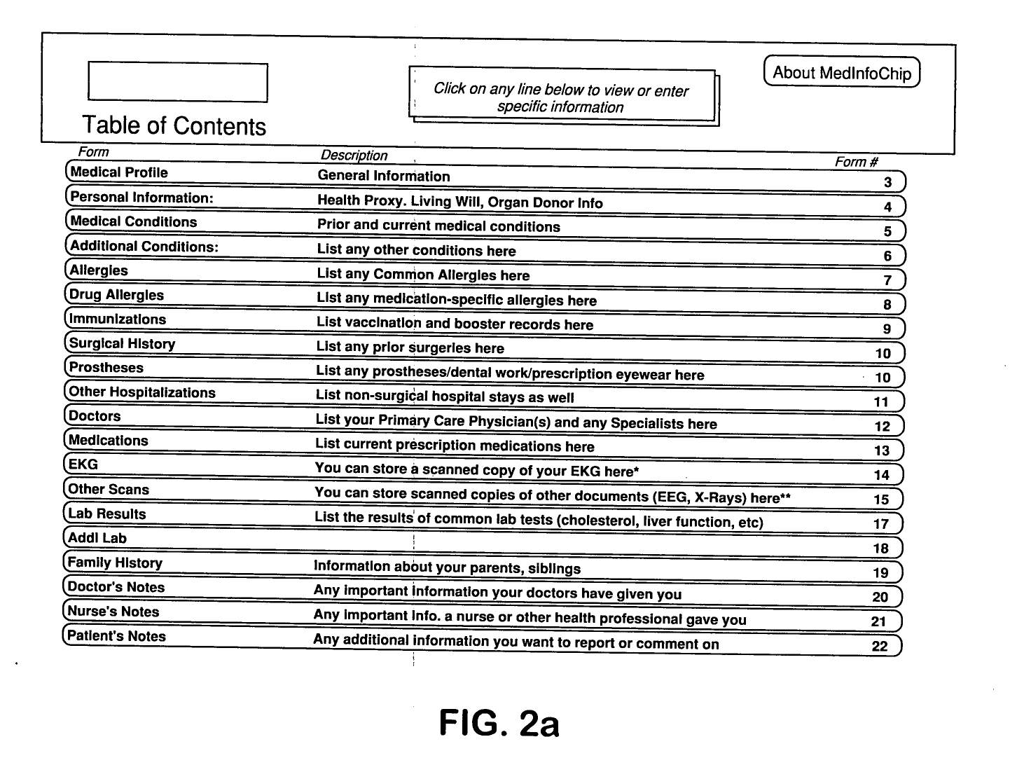

FIGS. 2 and 2a show alternate embodiments of the “Table of Contents” for the system. The application allows the user to store information pertaining to a variety of different aspects of their medical history, including, but not limited to: current medications, allergies, surgical history, names of doctors, health care and insurance providers, family history, graphs and lab reports. The user or health care provider can access any or all of this information by simply “clicking” the mouse on the desired field or page. That action will cause the application to go immediately and directly to that field or page. The patient's name automatically appears in the corresponding boxes at the top of the page.

In addition, each page contains a “print button”. By “clicking” the mouse on the print button, the user is able to print all of the pages representing their medical profile and history.

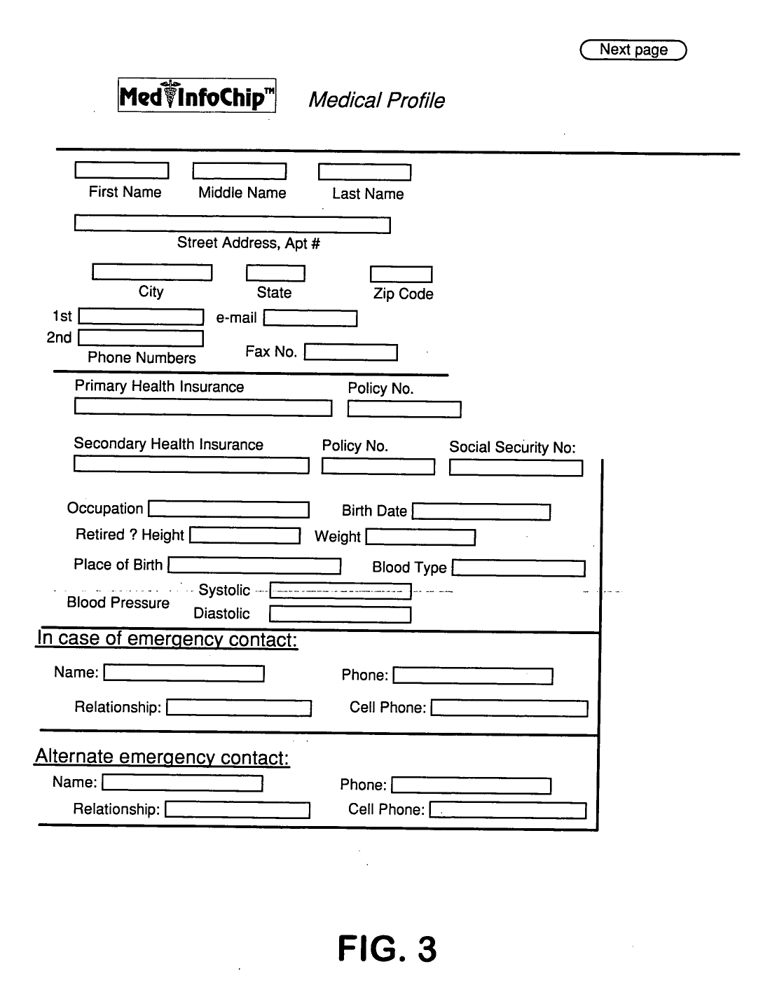

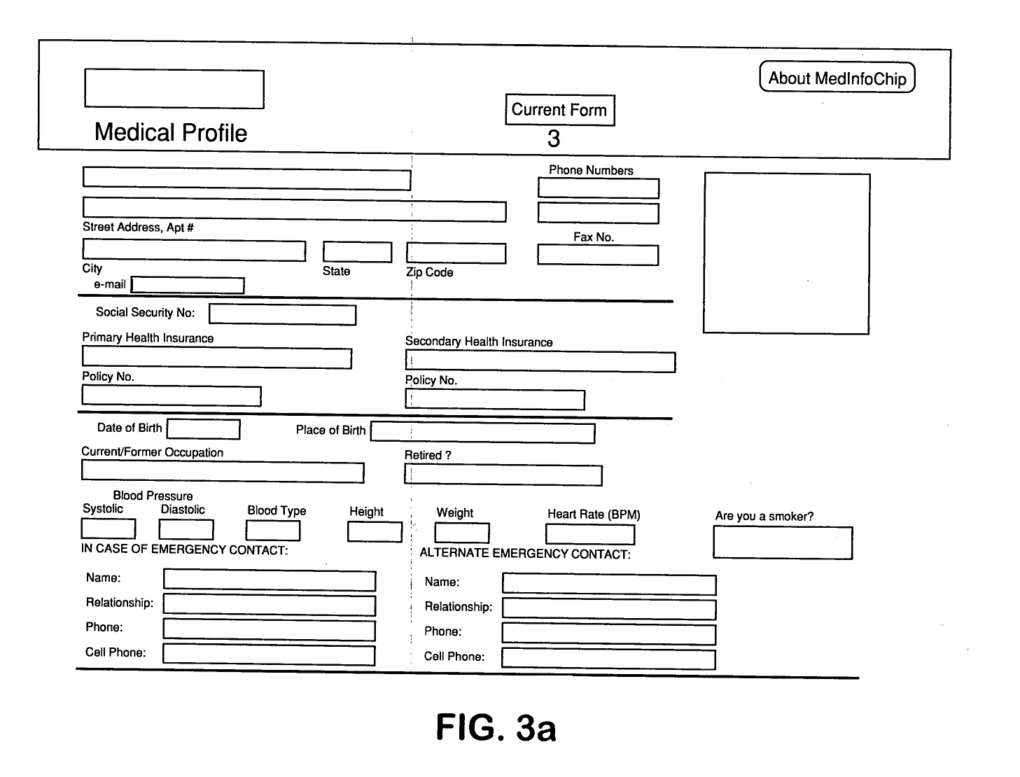

FIGS. 3 and 3a represent alternate embodiments of the “Medical Profile” field, which allows the user to enter basic information, such as, but not limited to the user's address, telephone number, insurance type and policy number and emergency contact information. General information such as occupation, height, weight, birth date, blood type and blood pressure are also stored here for quick access.

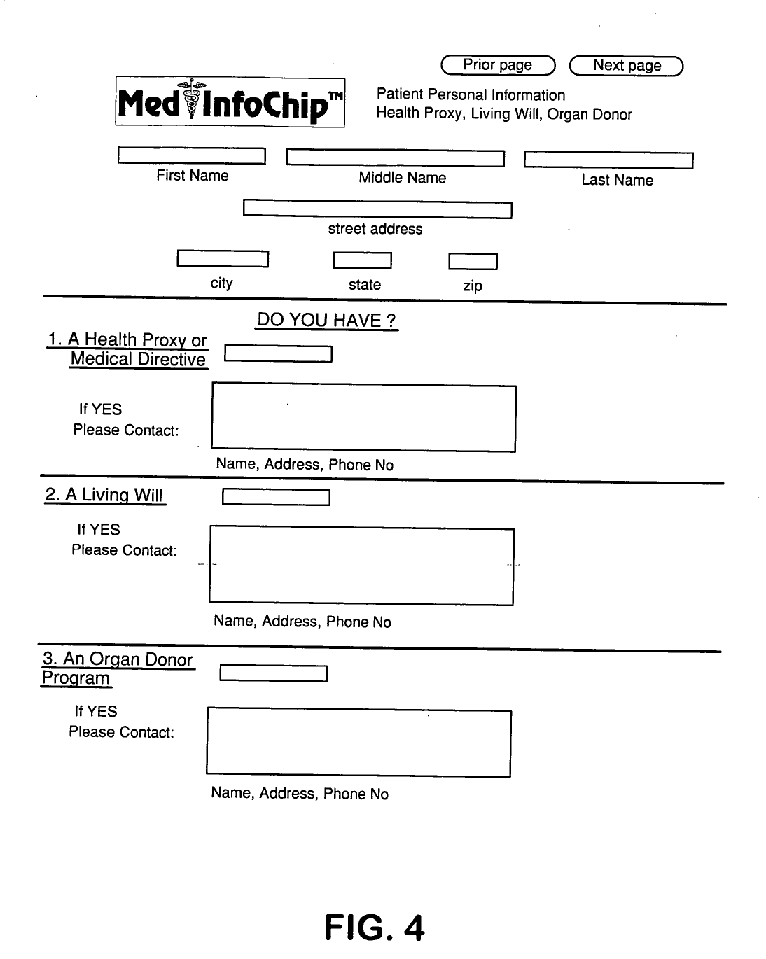

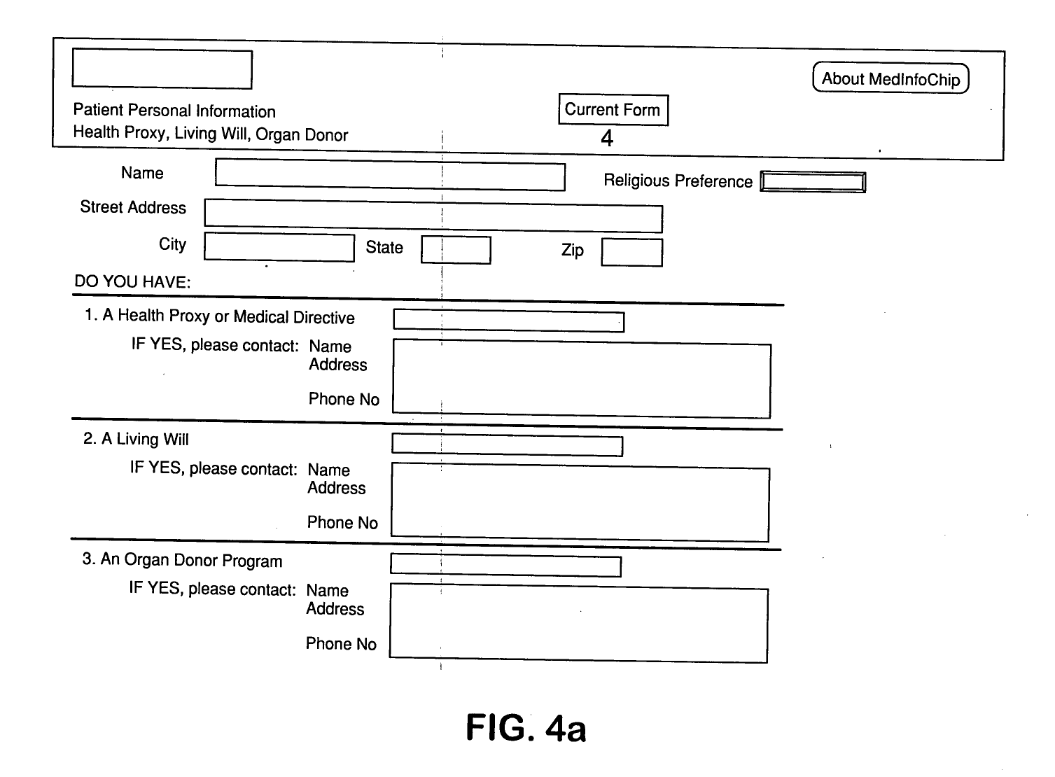

FIGS. 4 and 4a represent alternate embodiments of the “Patient Personal Information” field, which contains information concerning the existence of various legal documents, such as a health proxy, a living will and an organ donation program. If any of these documents exists, a contact name is given who is to be contacted to obtain more information about these documents, or actual copies of them.

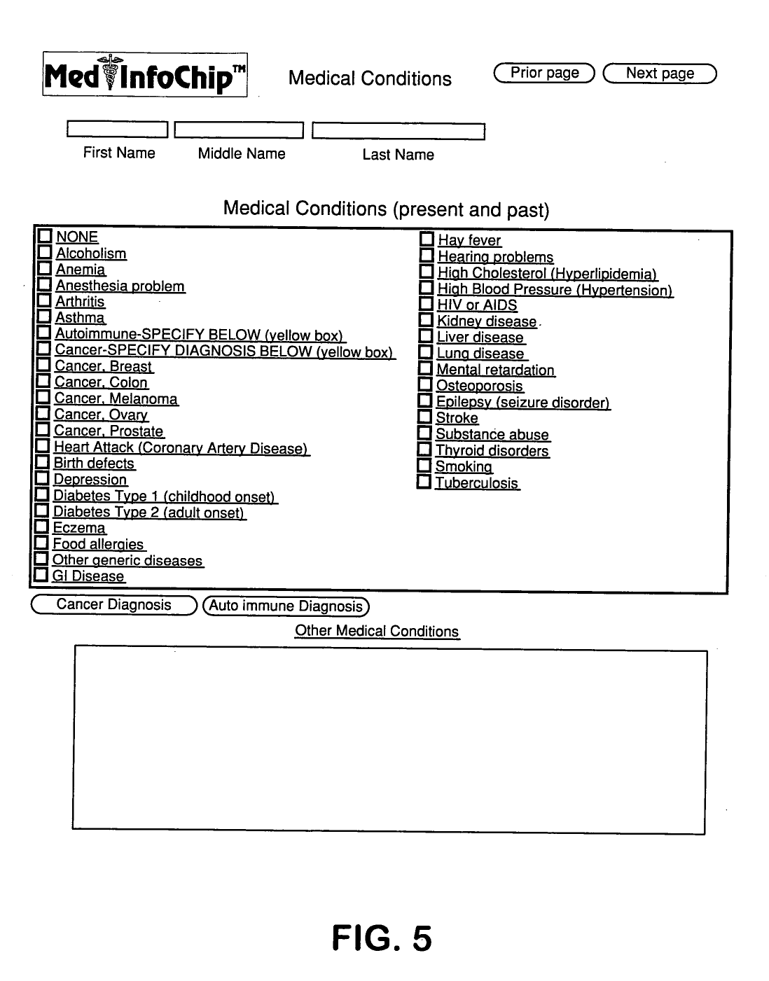

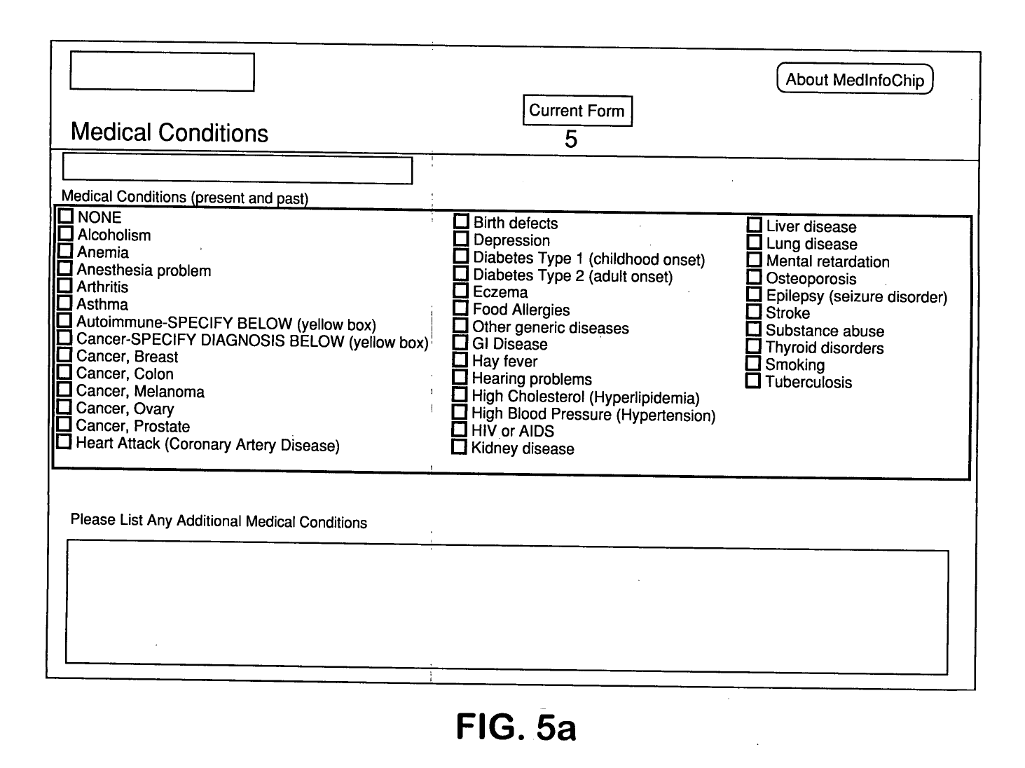

FIGS. 5 and 5a represent alternate embodiments of the “Medical Conditions” field, where the user can select the applicable conditions by “clicking” the box to the left of the corresponding term. These boxes attempt to identify the most common conditions. However, there are obviously more rare conditions which are not listed on this field. The lower area on the field allows the user to describe those less common conditions.

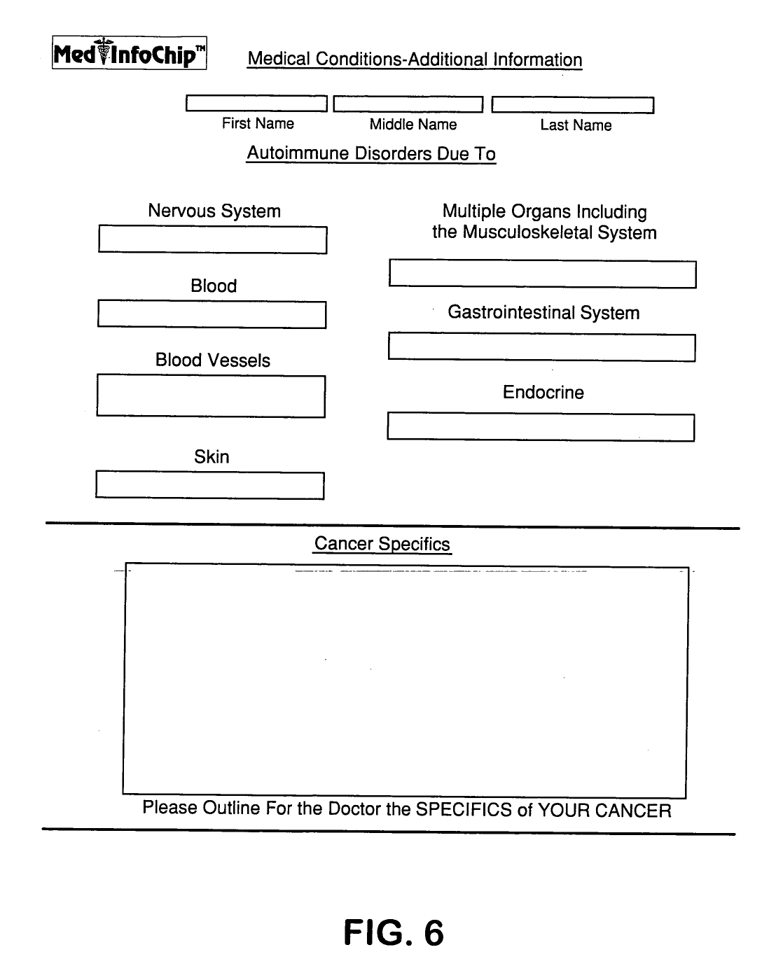

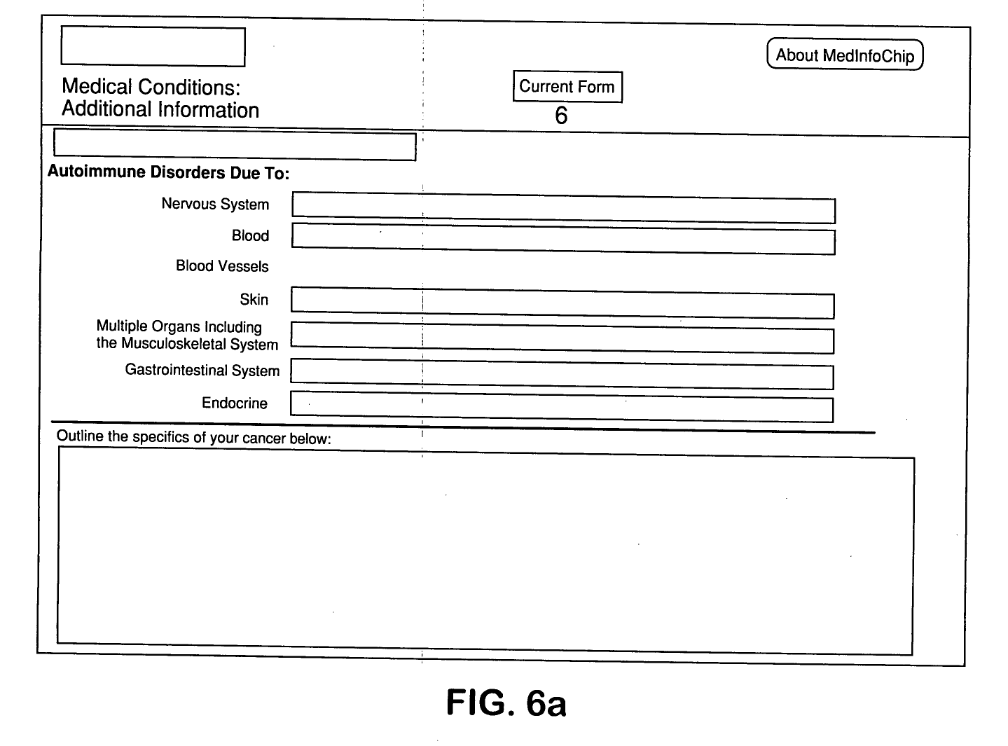

FIGS. 6 and 6a represent alternate embodiments of the “Medical Conditions—Additional Information”, which allows the user to enter specific data associated with autoimmune disorders and cancer.

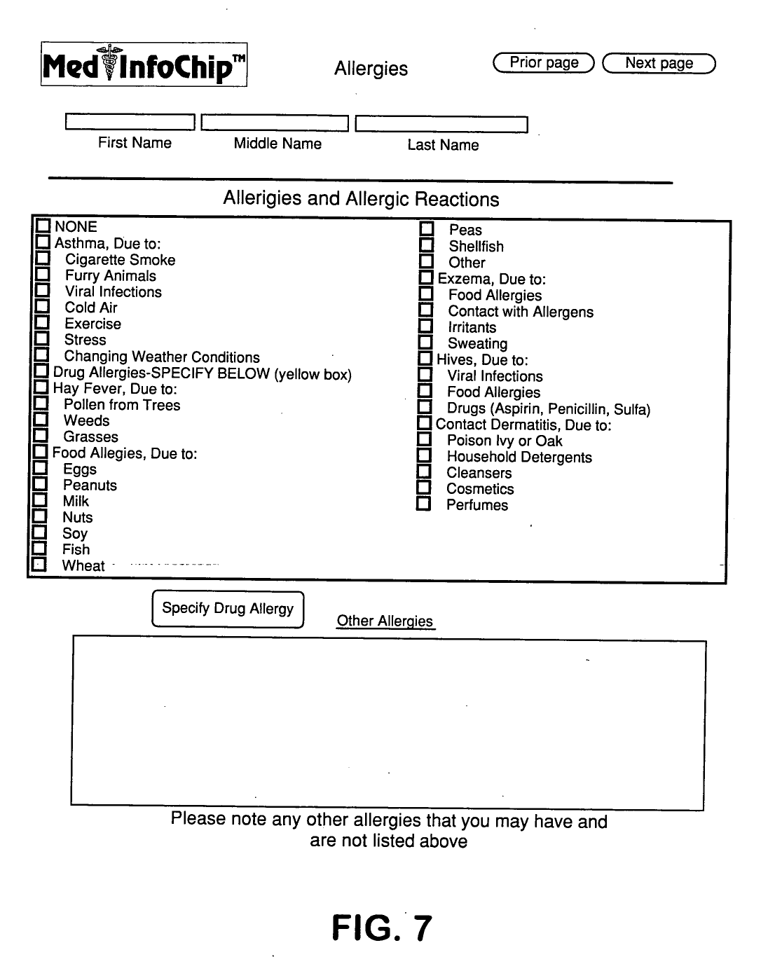

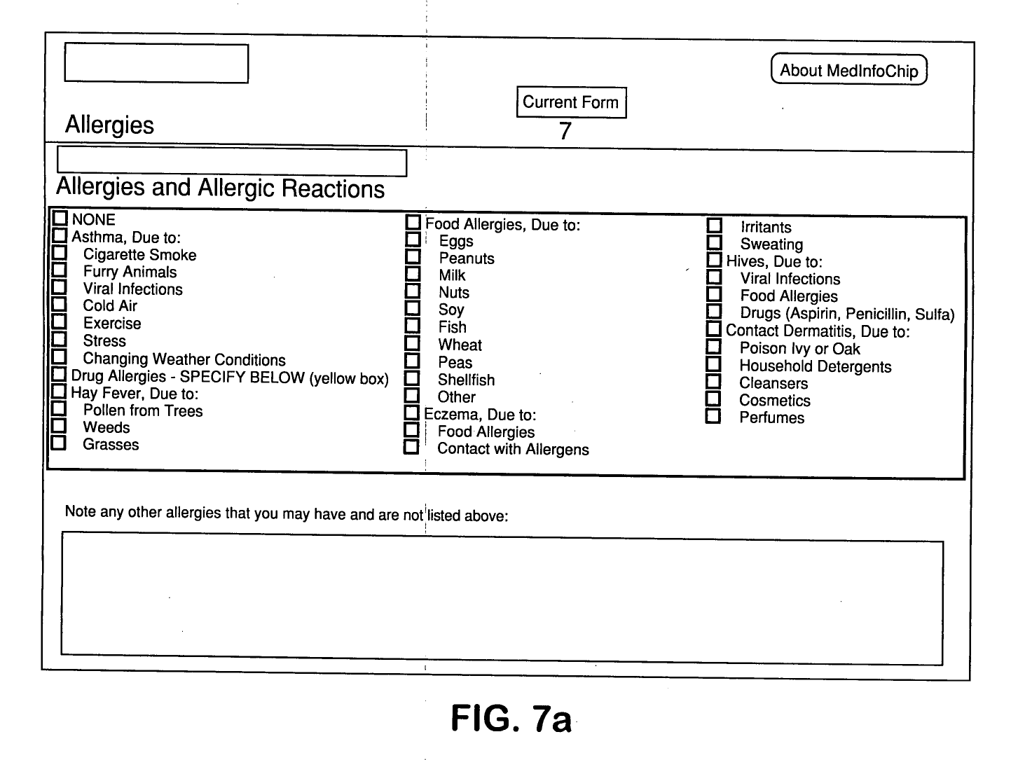

FIGS. 7 and 7a represent alternate embodiments of the “Allergies” field, where the user can select the applicable allergies by “clicking” the box to the left of the corresponding term. In a manner similar to the “Medical Conditions” field, these boxes attempt to identify the most common allergies. However, there are obviously more rare allergies which are not listed on this field. The lower area of the field allows the user to describe those less common allergies.

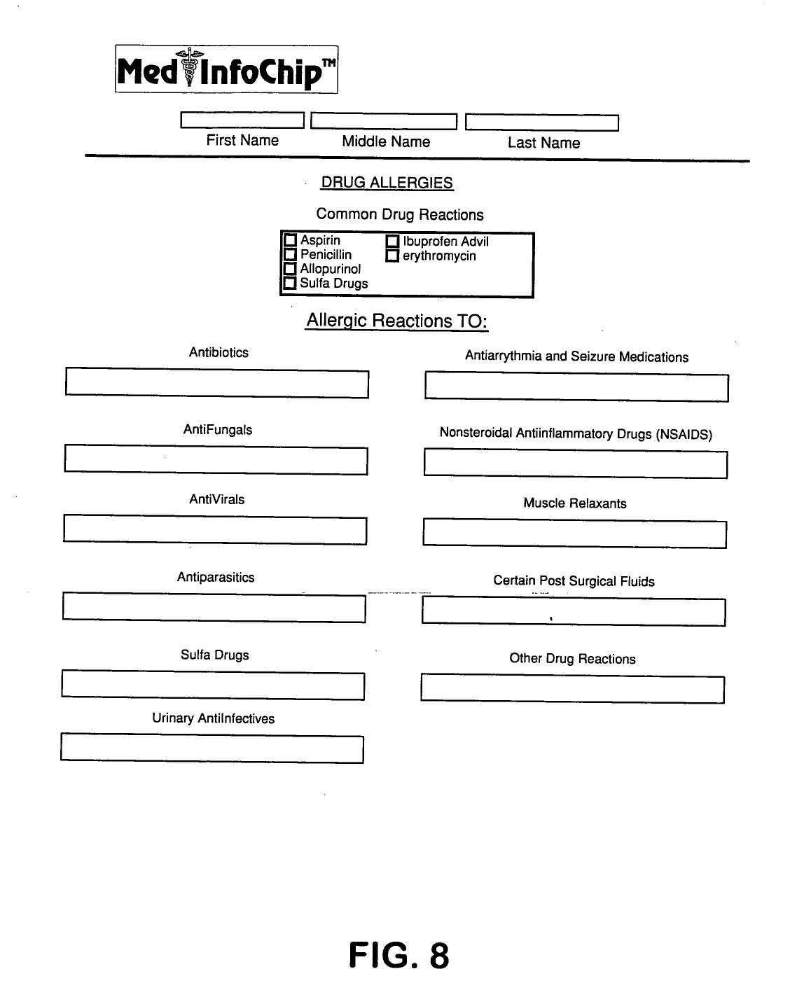

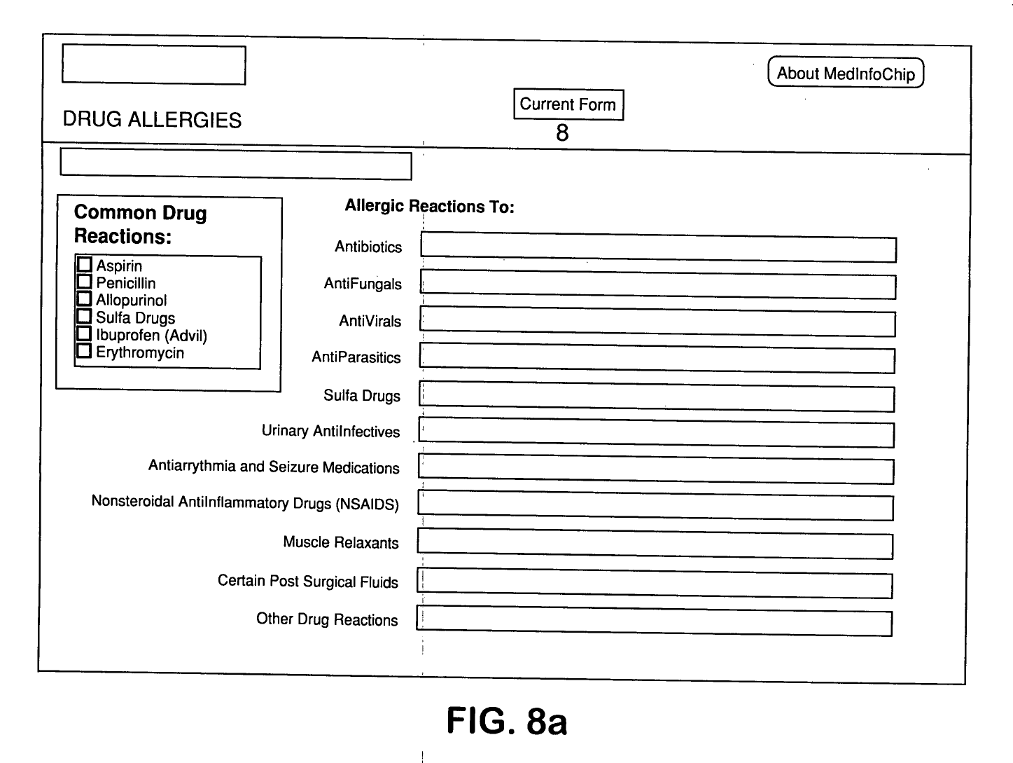

FIGS. 8 and 8a represent alternate embodiments of the “Drug Allergies” field, where the user can select the applicable drug allergies by “clicking” the box to the left of the corresponding drug. However, there are obviously more allergies which are not listed on this field. The lower area of the field is arranged categorically and allows the user to describe those less common allergies based on the type of drug.

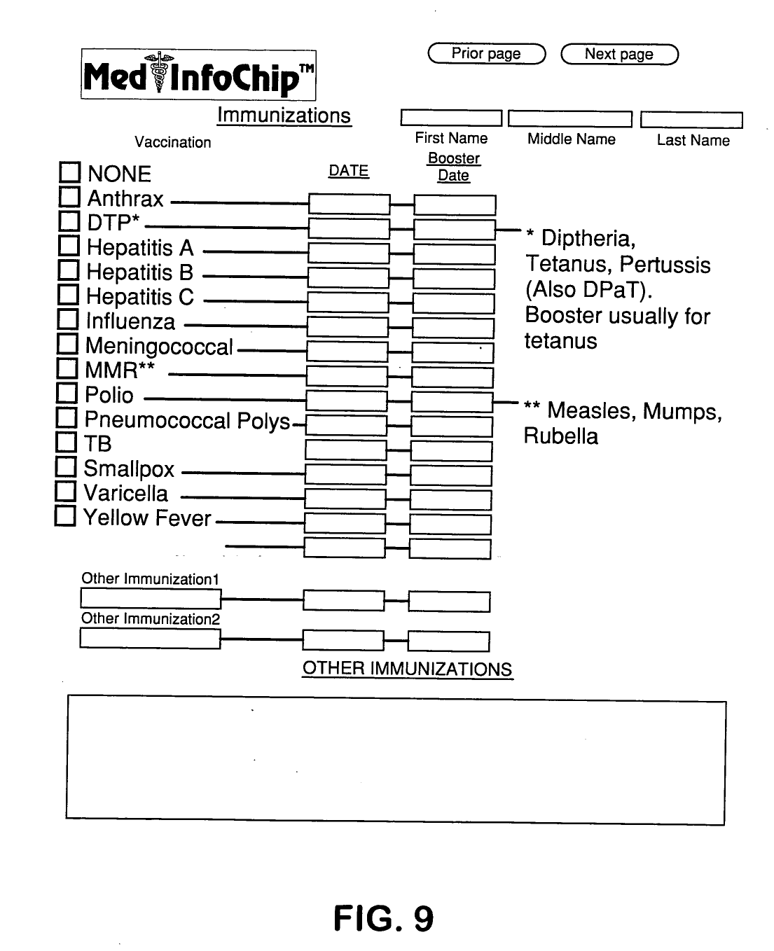

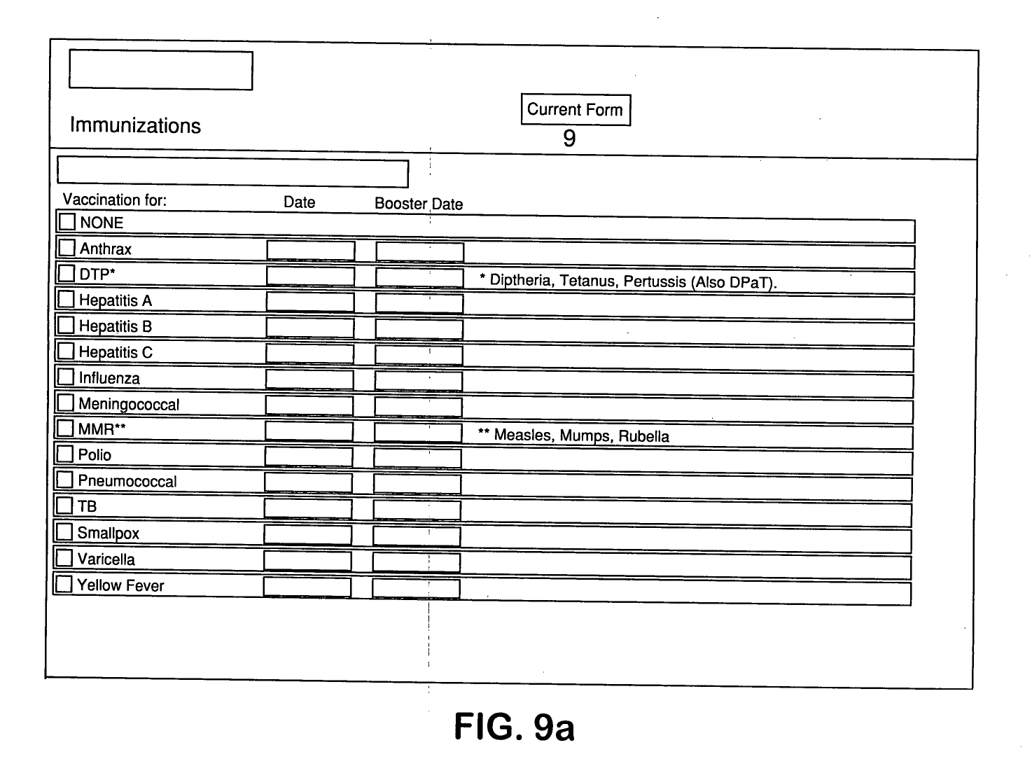

FIGS. 9 and 9a represent alternate embodiments of the “Immunizations” field, which lists the most popular diseases and vaccines. The field allows the user to enter the date of the immunization and any follow-up boosters that may have been given. For less common immunizations, an area is provided in the lower part of the field in which the user can enter information.

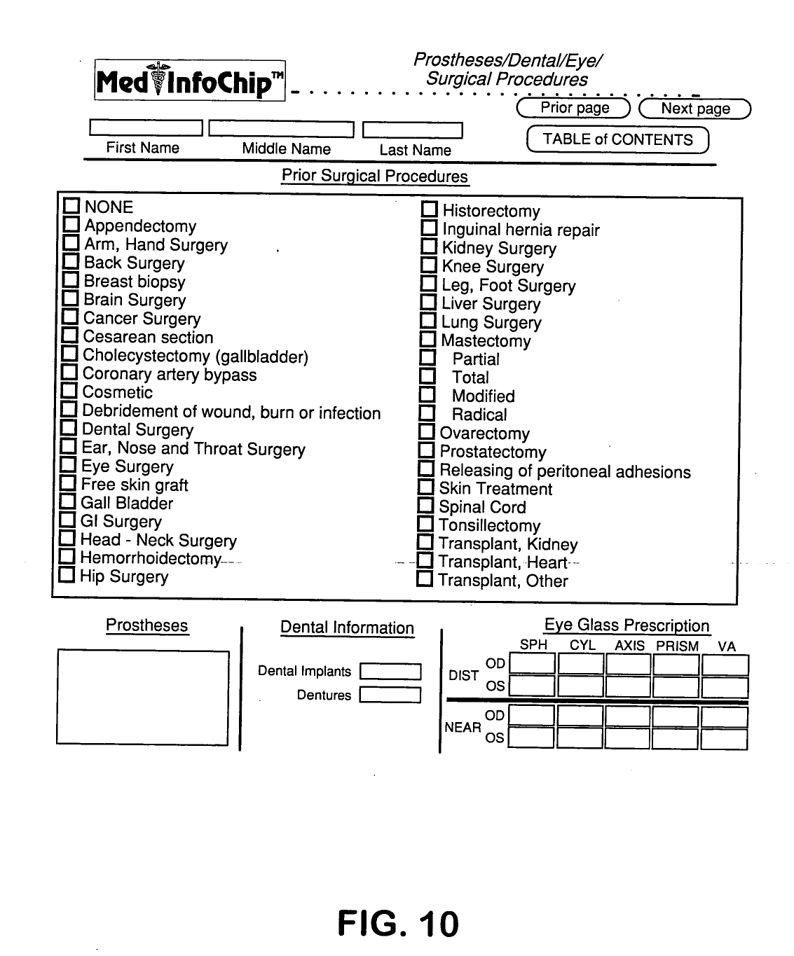

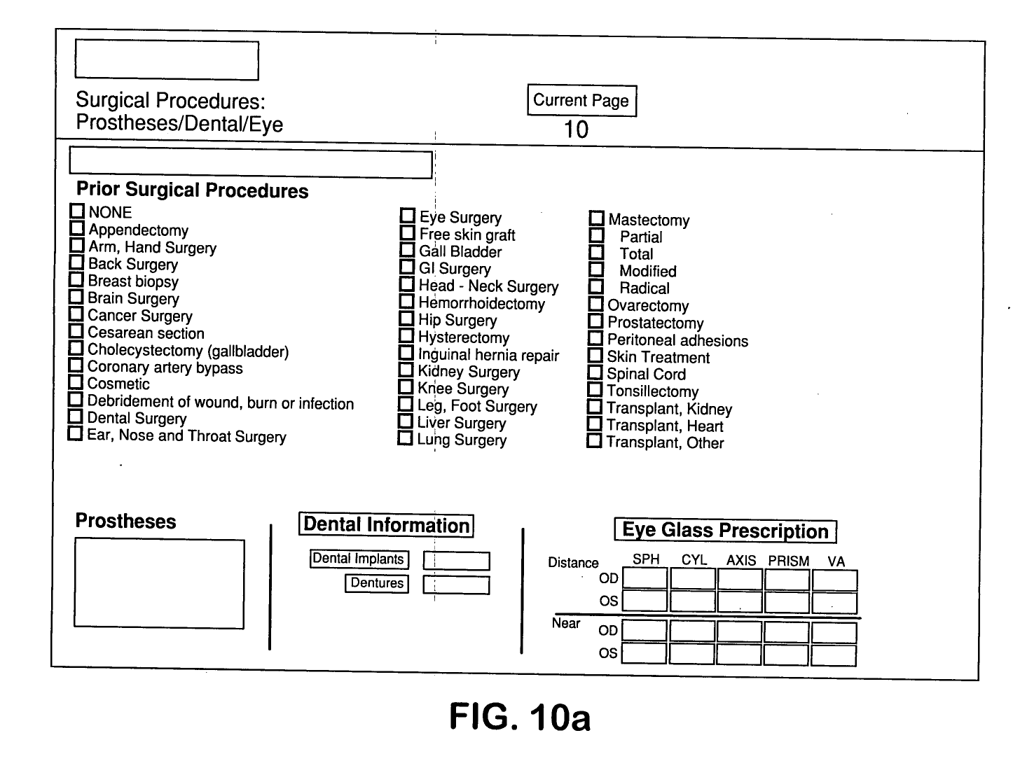

FIGS. 10 and 10a represent alternate embodiments of the “Prostheses/Dental/Eye/Surgical Procedures” field. Prior surgical procedures can be selected by “clicking” on the corresponding box to the left of the applicable procedure. The user enters information about prostheses, dental information and corrective lens prescriptions by typing in the relevant fields.

Including information such as corrective lens prescription illustrates the utility of the present invention. Often, people on vacation will lose or break their eyeglasses or contact lenses. Most people are unaware of their prescription and must attempt to contact their optometrist or ophthalmologist to obtain this information, or must wait until they return home to have the eyeglasses or lenses replaced. Conventional devices, such as medic bracelets, typically do not have the physical space to display non-critical information such as corrective lens prescriptions. In addition, corrective lens prescriptions often change, sometimes on an annual basis. This need to update the information frequently makes storage media such as microfilm and reduced printing inappropriate due to the inconvenience and difficulty in modifying the information once printed.

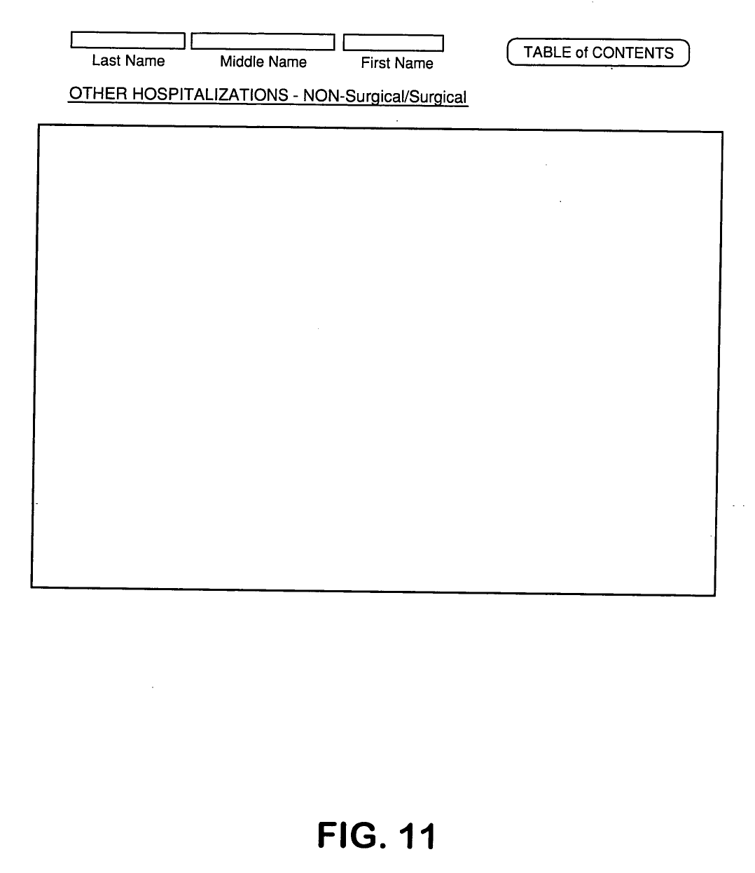

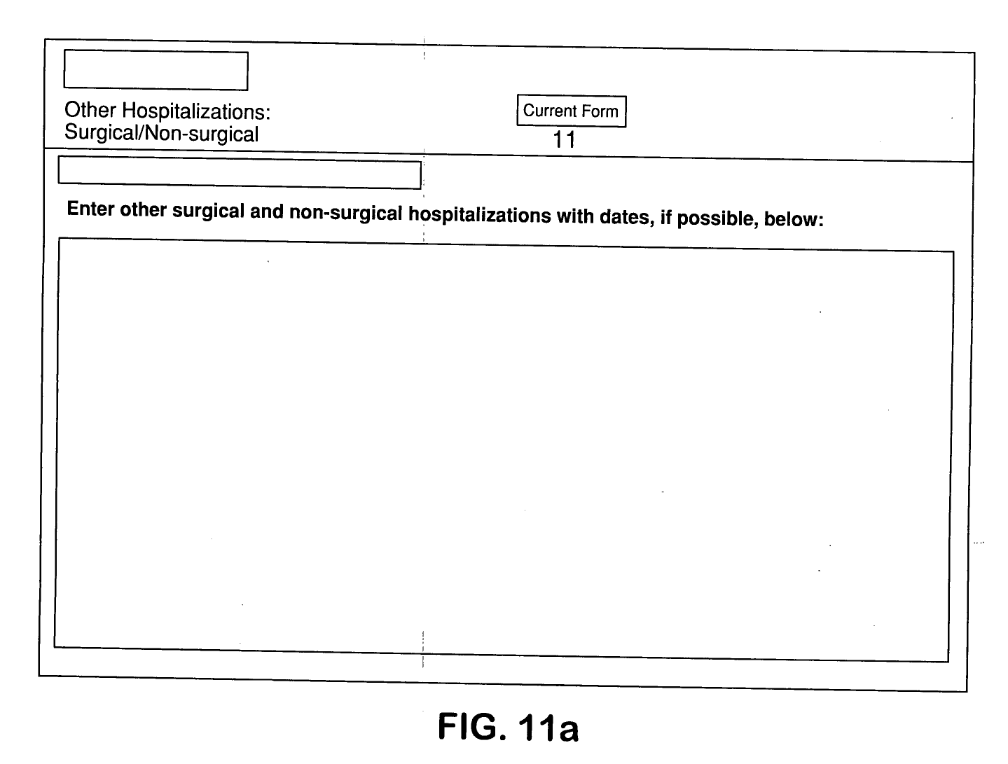

FIGS. 11 and 11a represent alternate embodiments of an “Other Hospitalizations” field, where the user can input additional information, not described in FIG. 10, about other less common surgical and non-surgical procedures.

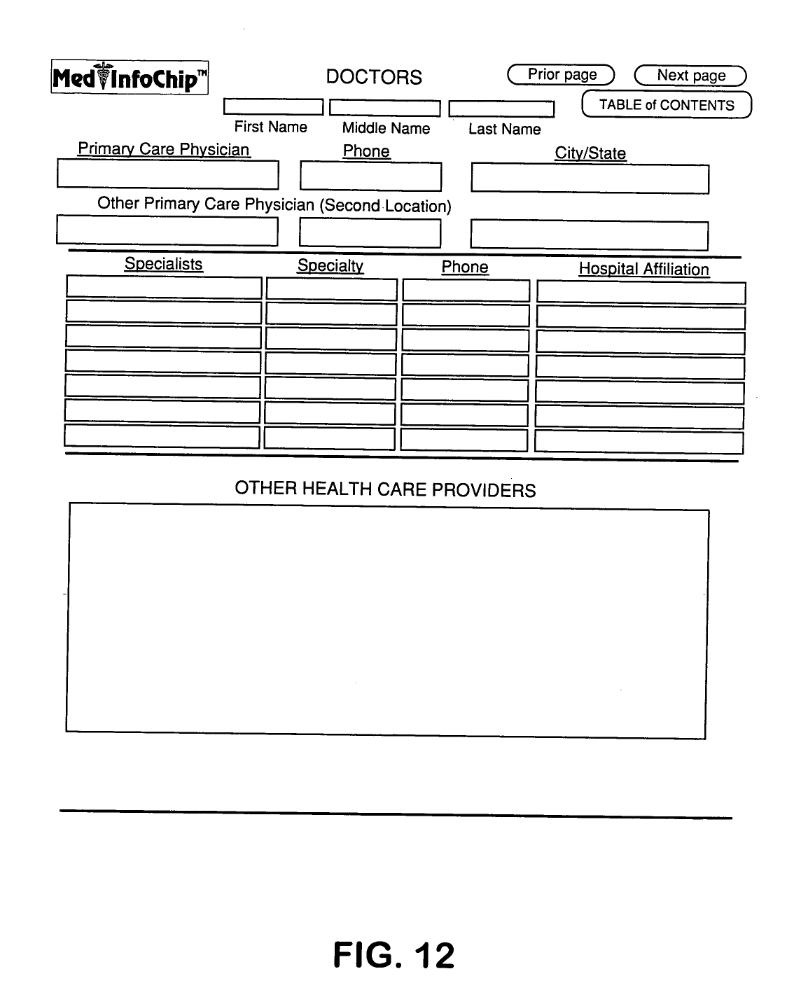

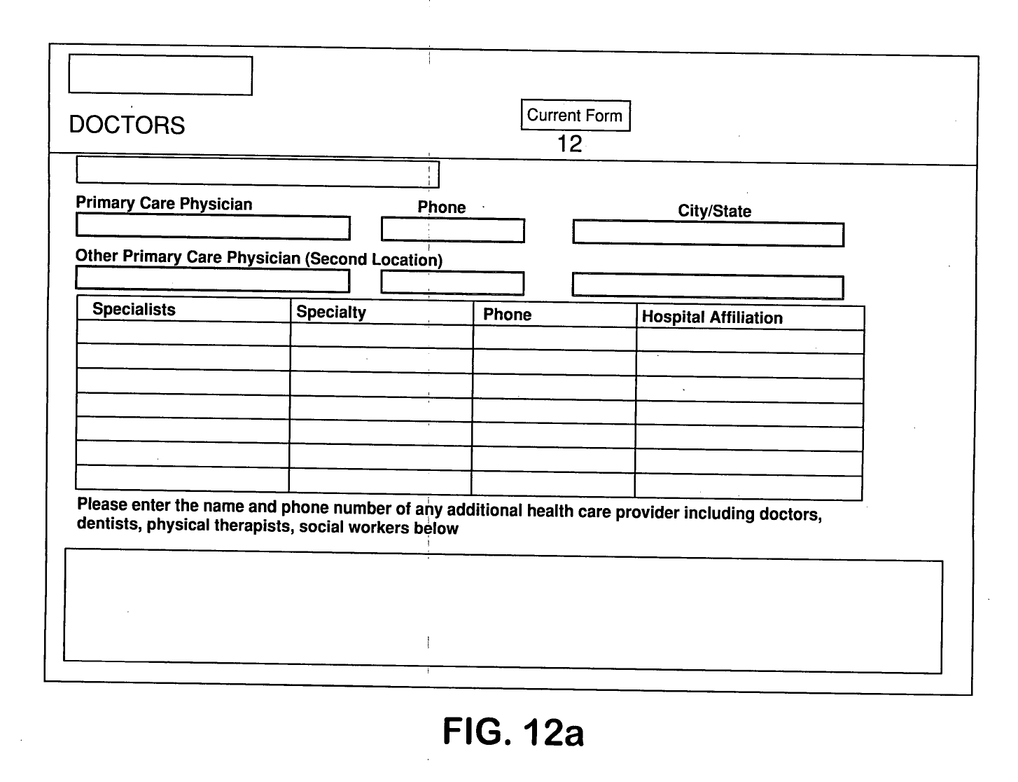

FIGS. 12 and 12a represent alternate embodiments of the “Doctors” field. This field allows the user to enter the name of their primary care physician, and any other specialists that the patient has consulted with. For example, a patient may have a primary care physician, a cardiologist for a heart condition, and an oncologist for cancer treatment. The specific information about each provider, including their specialty, phone number and hospital affiliation can be inputted by entering the corresponding fields. The lower half of the field allows the user to enter any other health care providers that they are associated with.

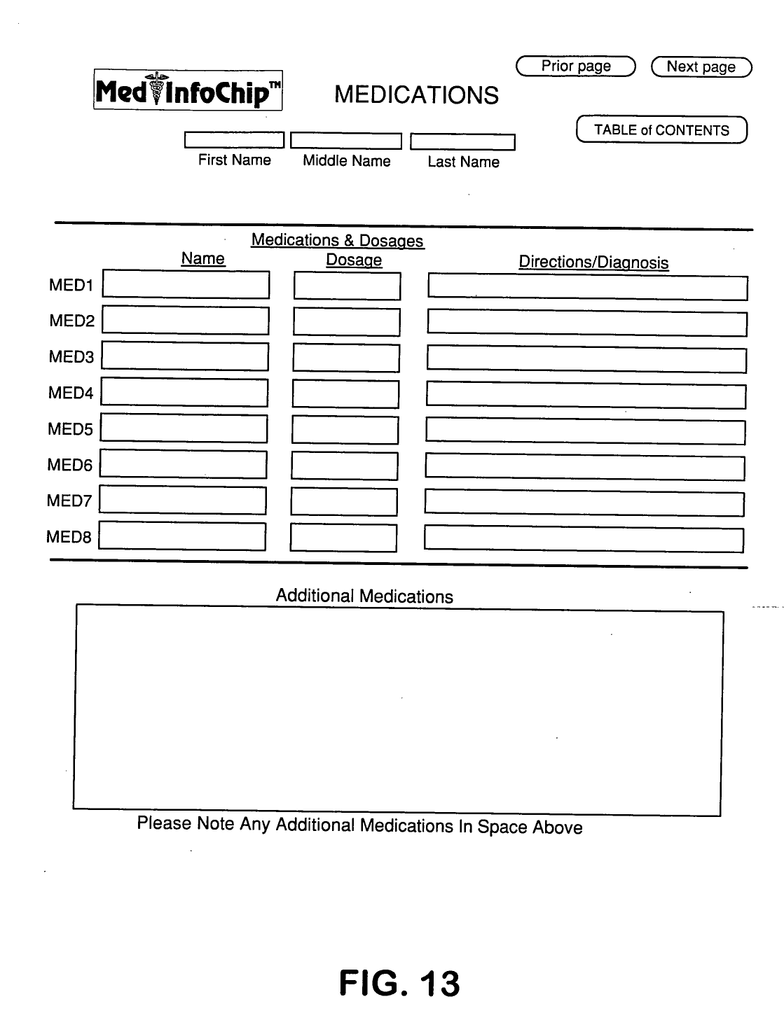

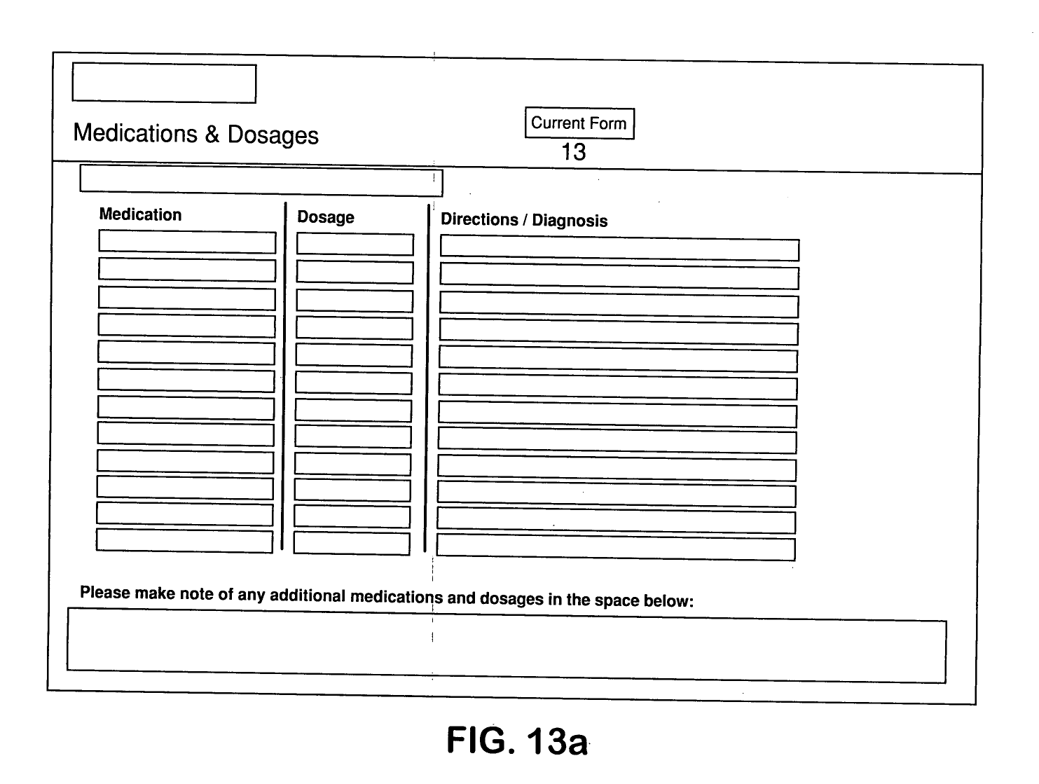

FIGS. 13 and 13a represent alternate embodiments of the “Medications” field. This field allows the user to enter all of the medications and specific dosages that they are currently using, along with the diagnosed ailment that the medication is being used to treat. Similar to the corrective lens prescription information, saving the user's medication and dosage information allows the user a convenient way to obtain or renew prescriptions while away from home. Most importantly, it also allows the physician to evaluate adverse drug interactions between those that the patient is currently taking and any new drugs that the physician is contemplating. Since patients may be seeing a plurality of doctors, such as a general practitioner, a heart specialist, an oncologist and others, it may be difficult for any of these doctors to be aware of all of the prescription drugs that the patient is currently taking. By saving this information, each of these doctors has access to all of the patient's prescription drugs and dosages. The lower portion of the field represents additional medications, where the user can input additional information that they were unable to enter on the previous page due to lack of space.

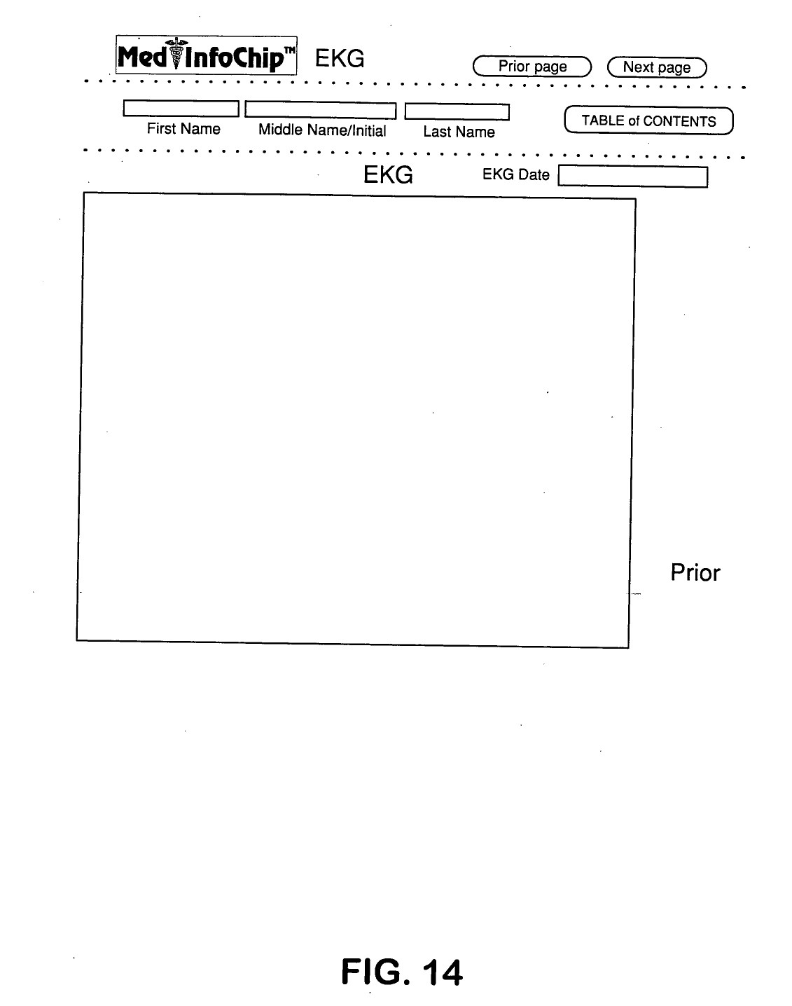

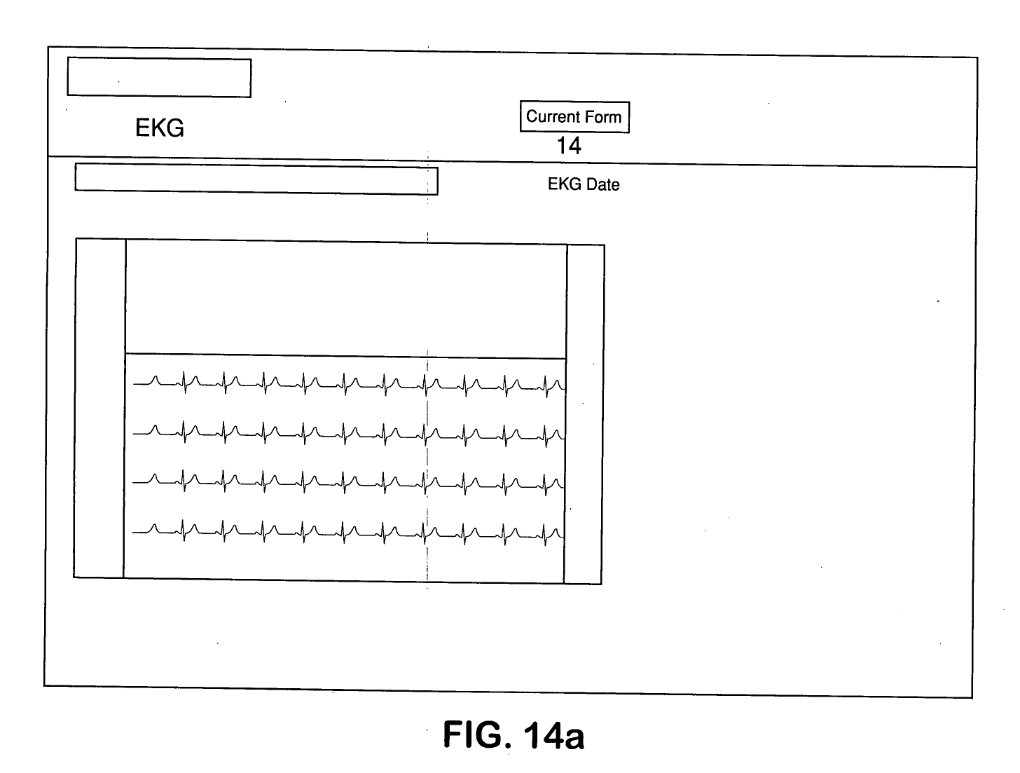

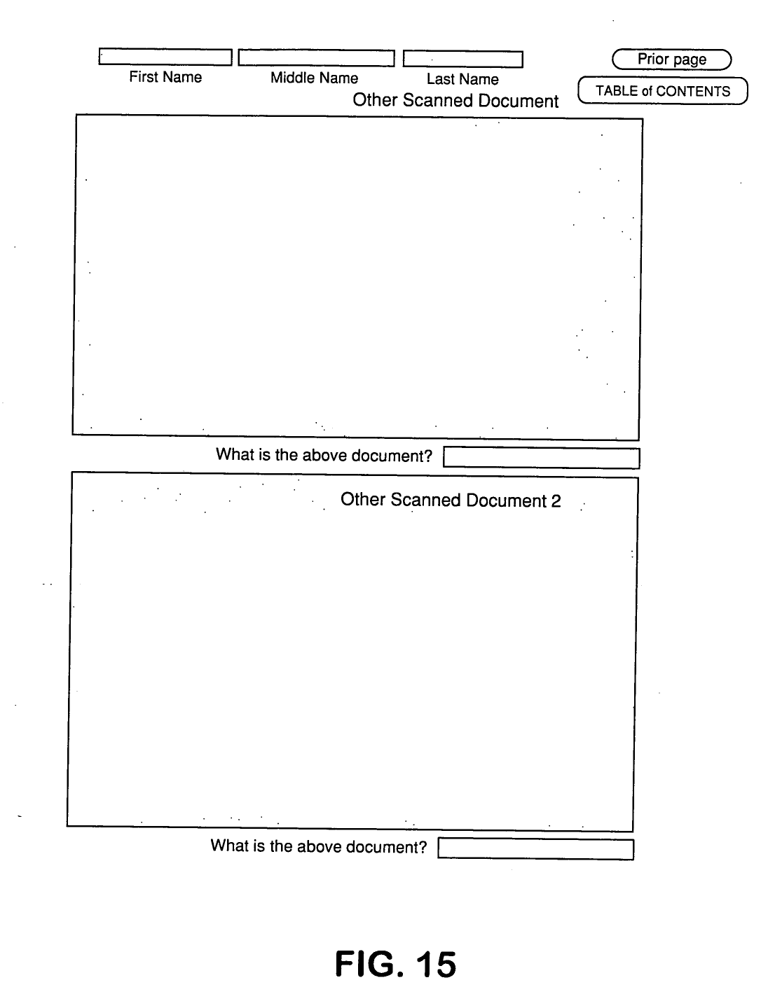

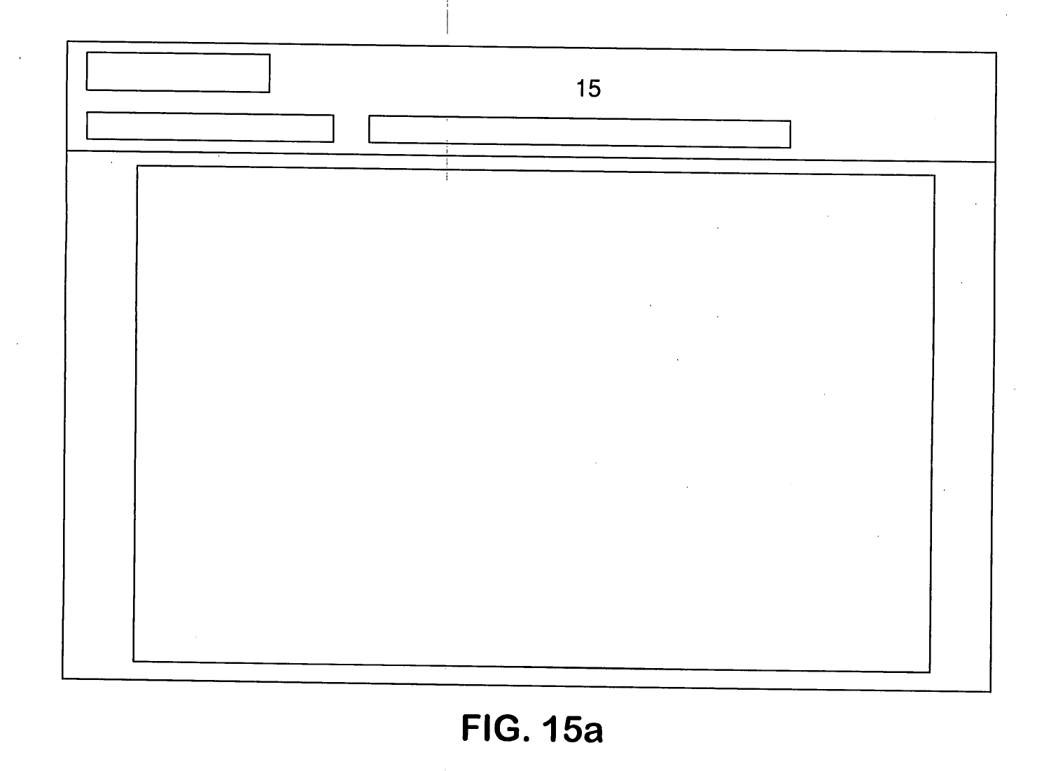

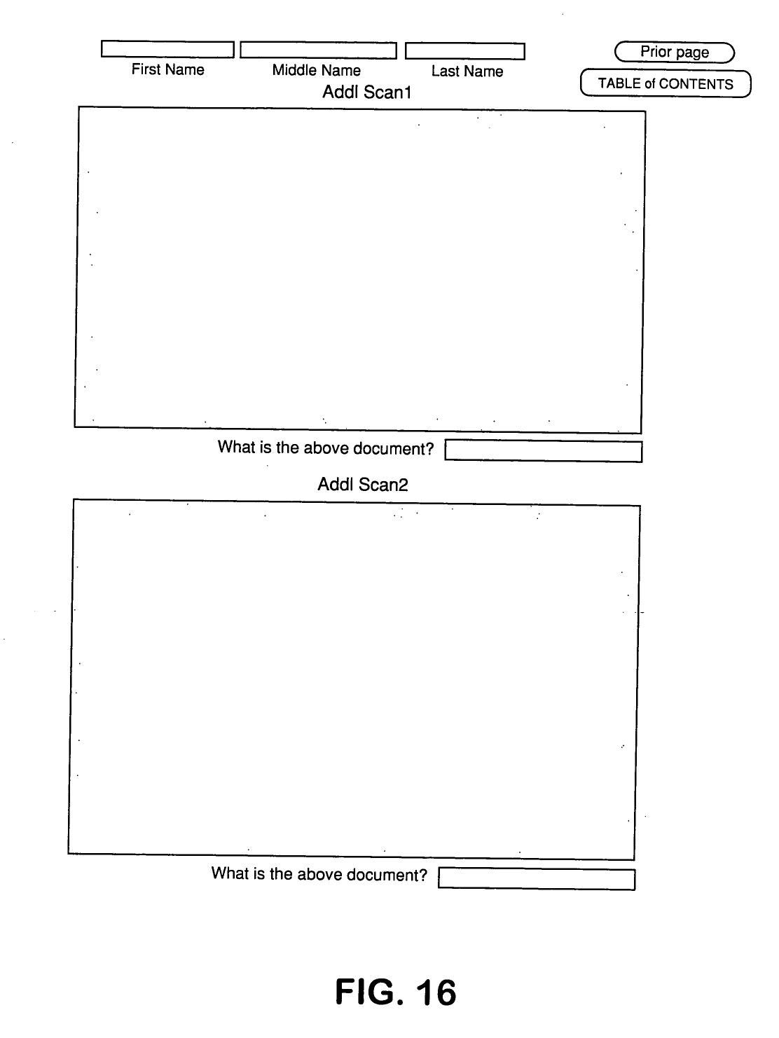

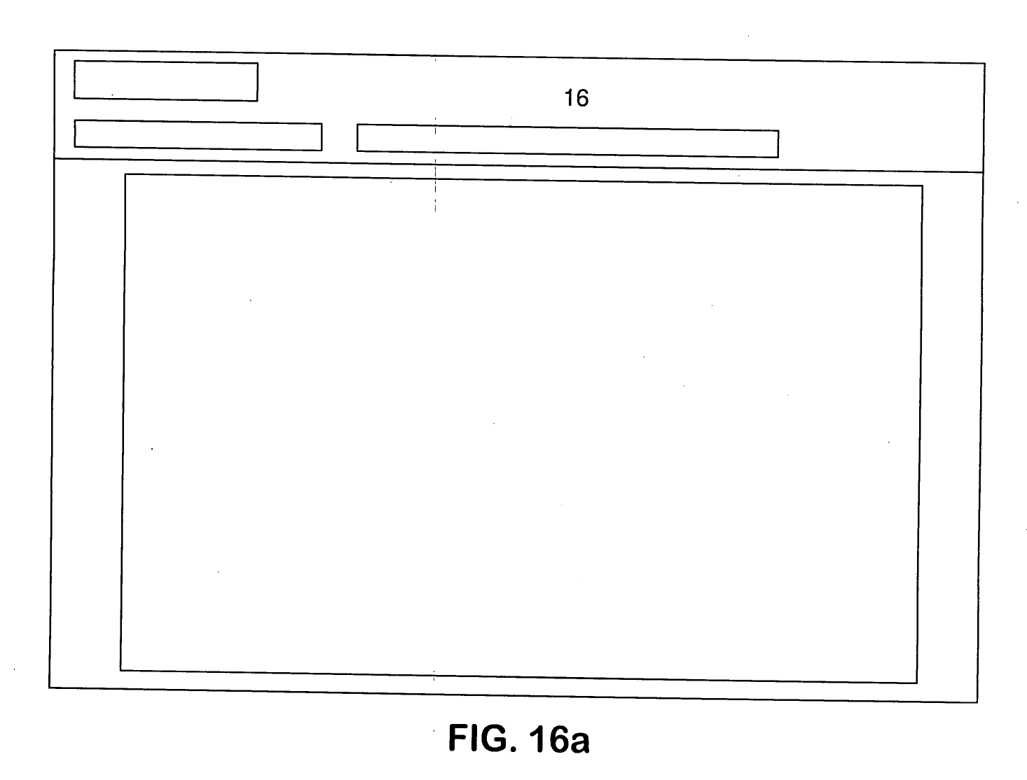

FIGS. 14 and 14a represent alternate embodiments of an “EKG” field, which allows the user to enter a pictorial representation of their EKG (as shown in FIG. 14a). Preferably, the EKG is in the form of a jpeg file, although other formats such as tiff files and bit maps are also possible. These can be inserted into the designated field. In the preferred embodiment, the user clicks on the shaded field and the application prompts the user to enter the name of the file that they want to insert. The inclusion of non-text based information offers significant benefits to both the user and the health care provider. Many forms of medical information do not naturally appear in text form. Items such as X-Rays, EKGs, MRIs, and sonograms are much more graphical in nature. The present invention allows those types of information to be entered and accessed in that graphical format. FIGS. 15 and 16, and 15a and 16a are alternate embodiments which offer additional space to include graphics other than the EKG saved in FIG. 14 (or alternatively, FIG. 14a). If additional images are recorded on these pages, the titles of those images will appear in the “Table of Contents” page as well. Alternatively, these supplemental pages can be used to record a series of like tests results, such as but not limited to EKGs, over an extended period of time. This allows a health care provider, who is not familiar with the patient's medical history to identify trends or abrupt changes in a particular test.

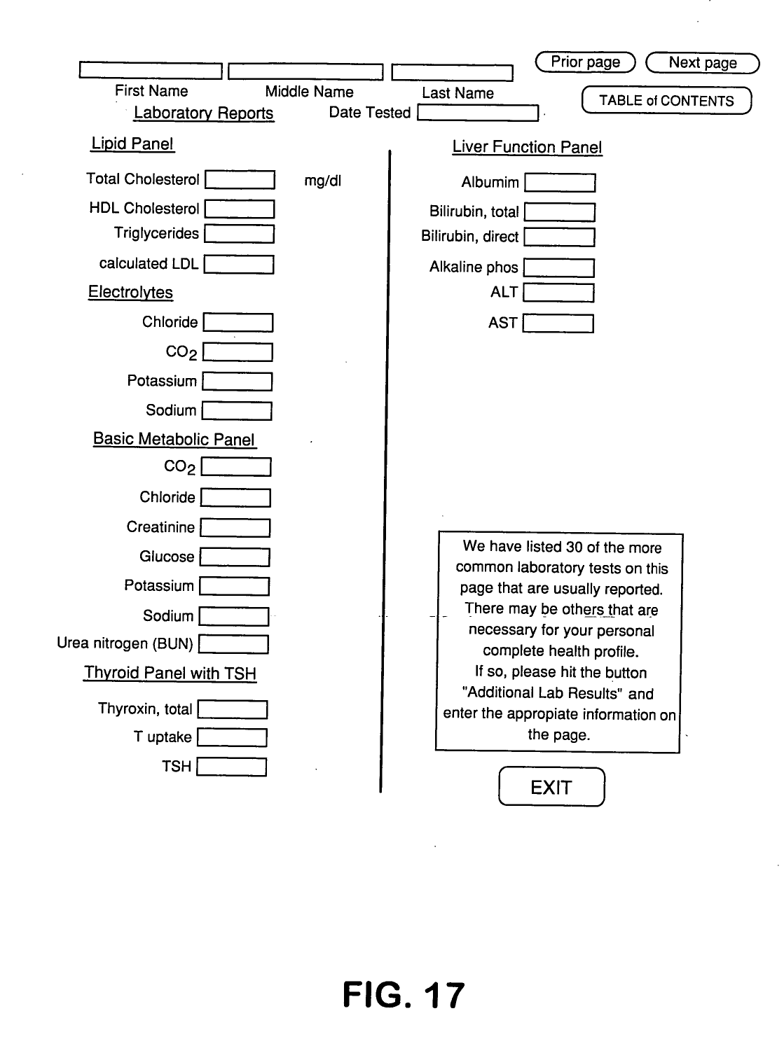

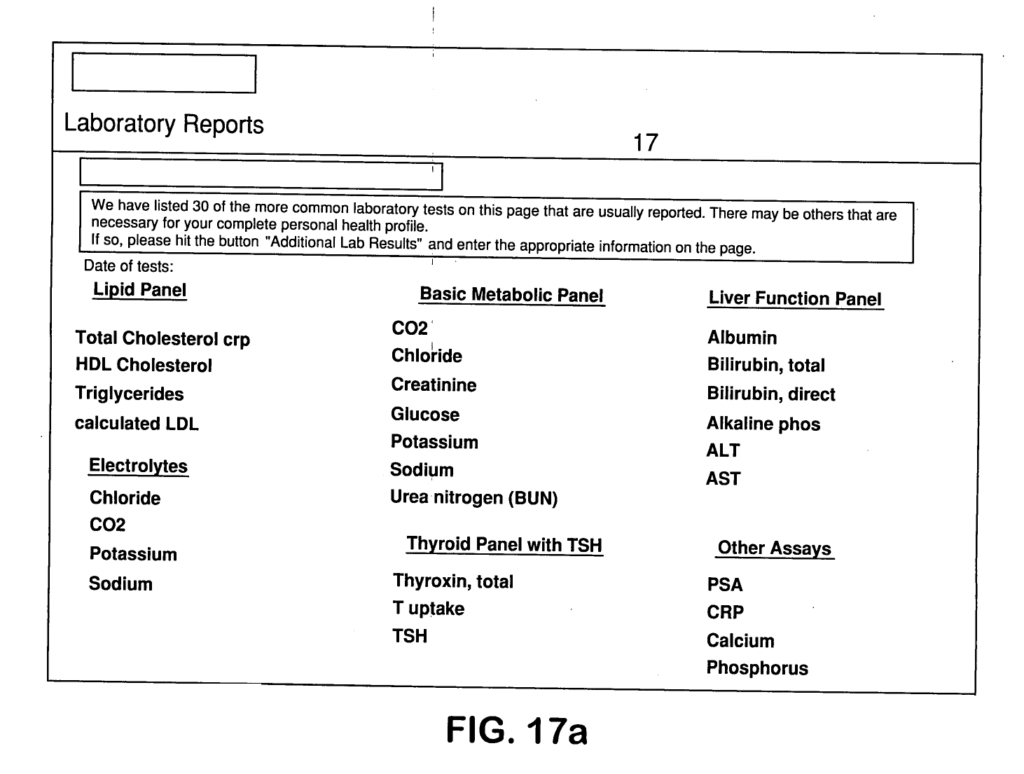

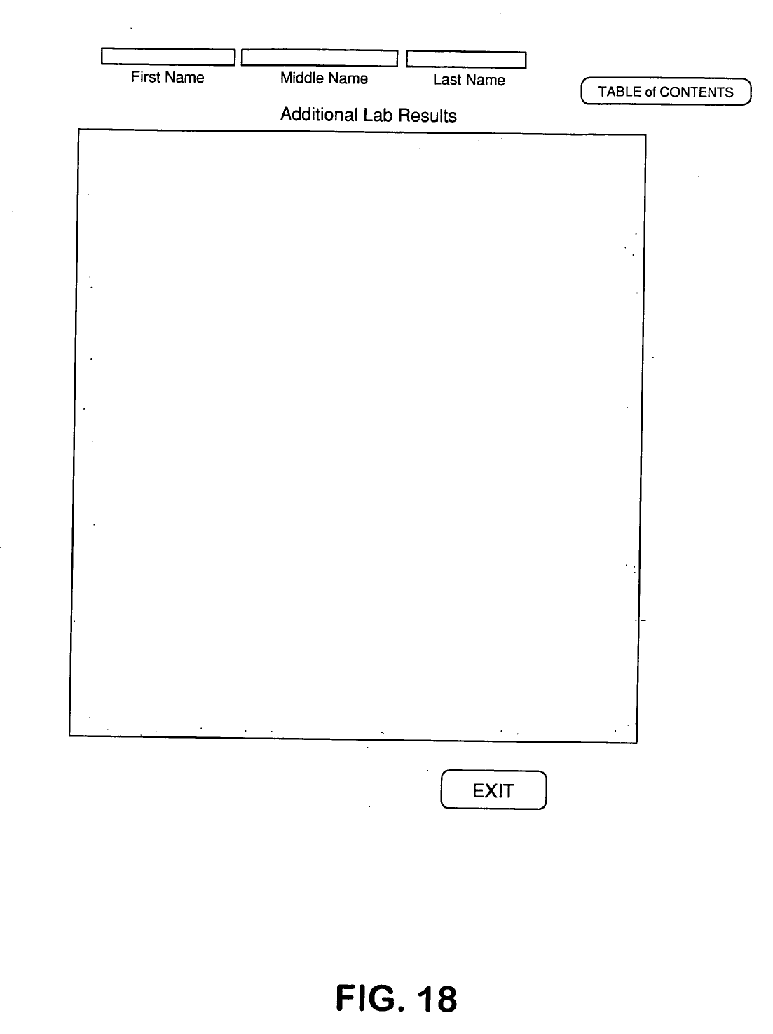

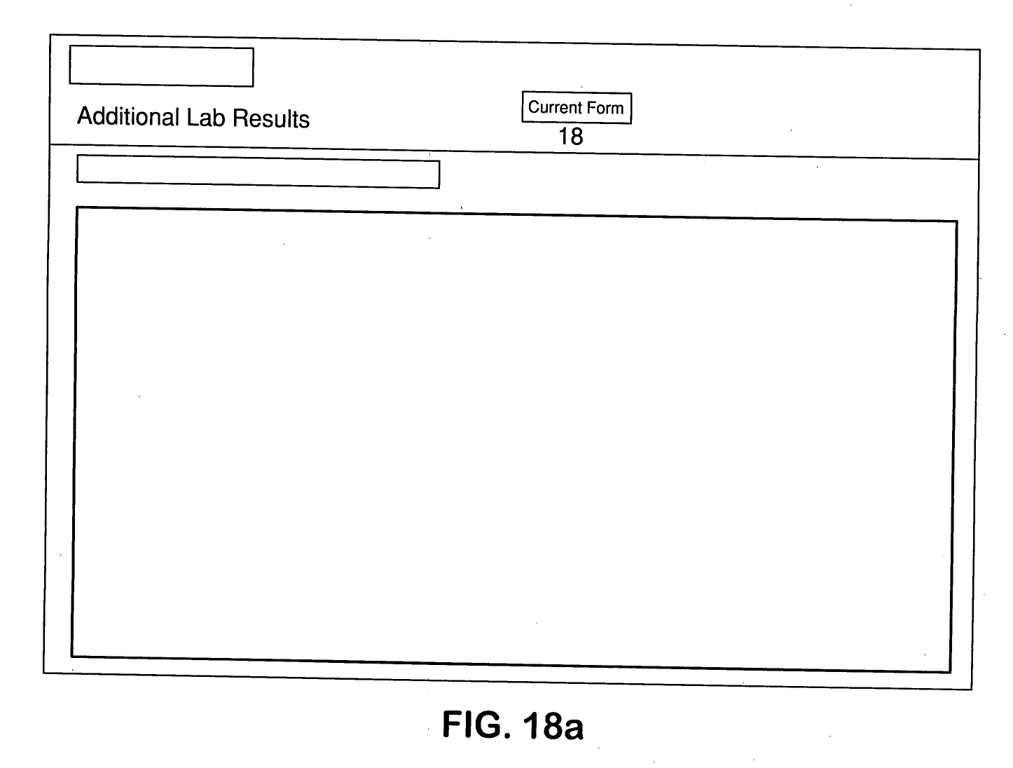

FIGS. 17 and 17a represent alternate embodiments of the “Laboratory Reports” field. In the preferred embodiment, many of the most common laboratory tests are listed, allowing the user to record the results by inputting into the appropriate fields adjacent to the test. If the user has undergone tests which are not included in this list, the user can enter those result by using the field shown in FIG. 18.

FIGS. 18 and 18a represent alternate embodiments of the “Additional Lab Results” page. The results of any tests that were not listed on FIG. 17 (or alternatively, FIG. 17a) are entered by typing into the shaded area.

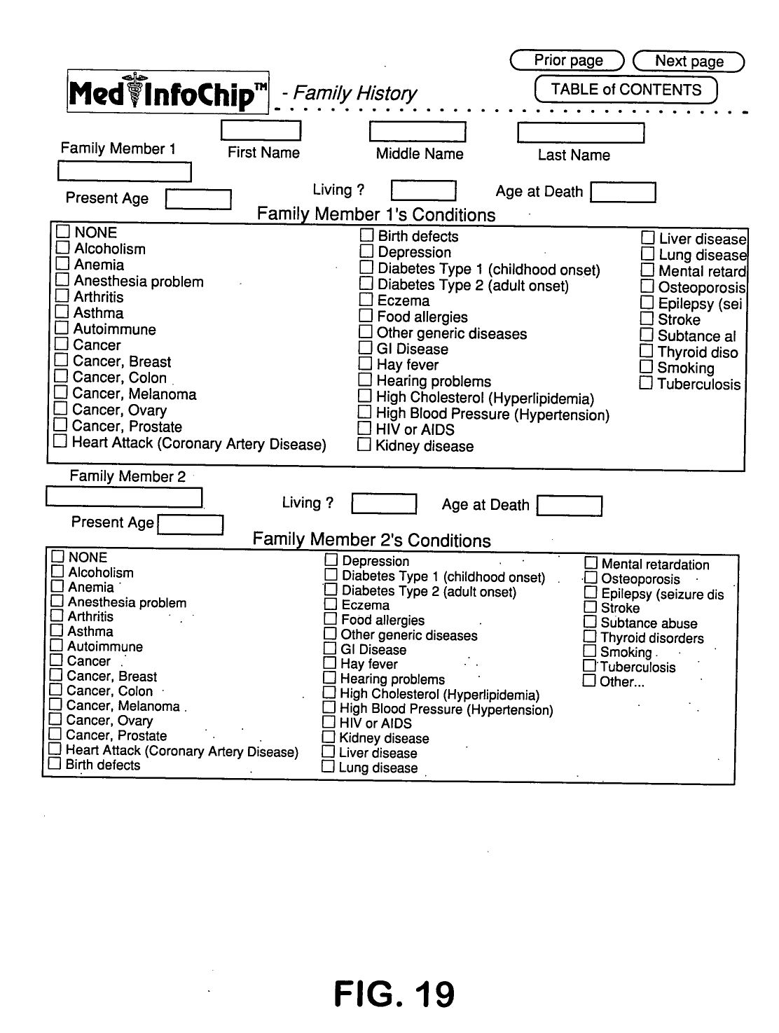

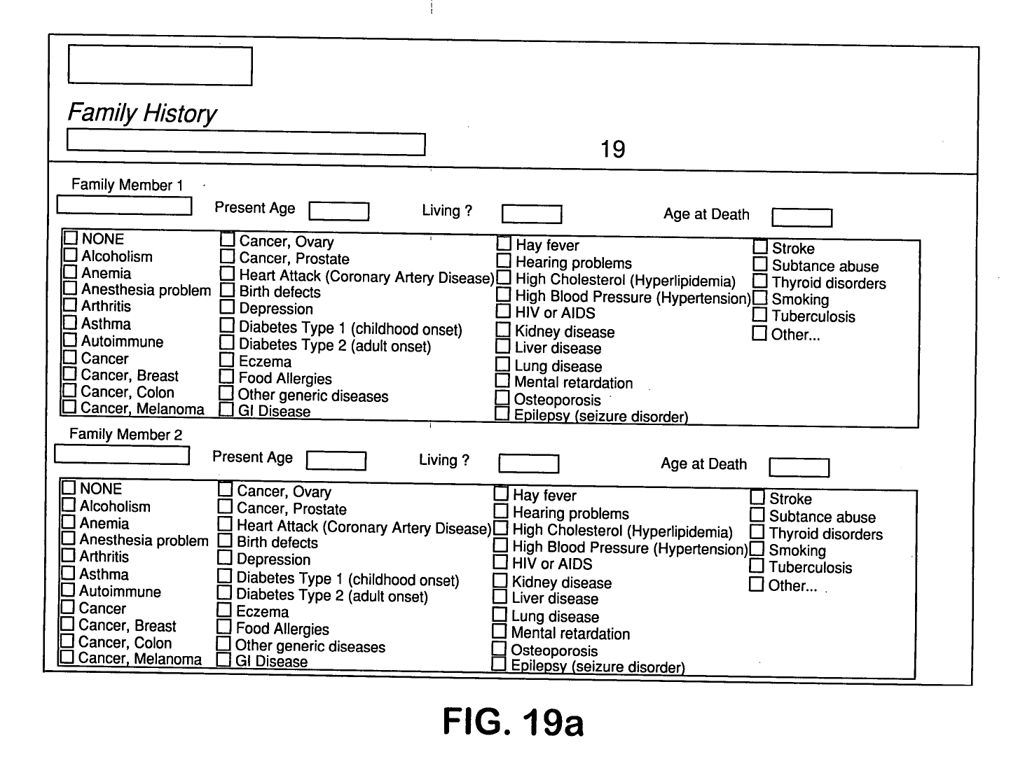

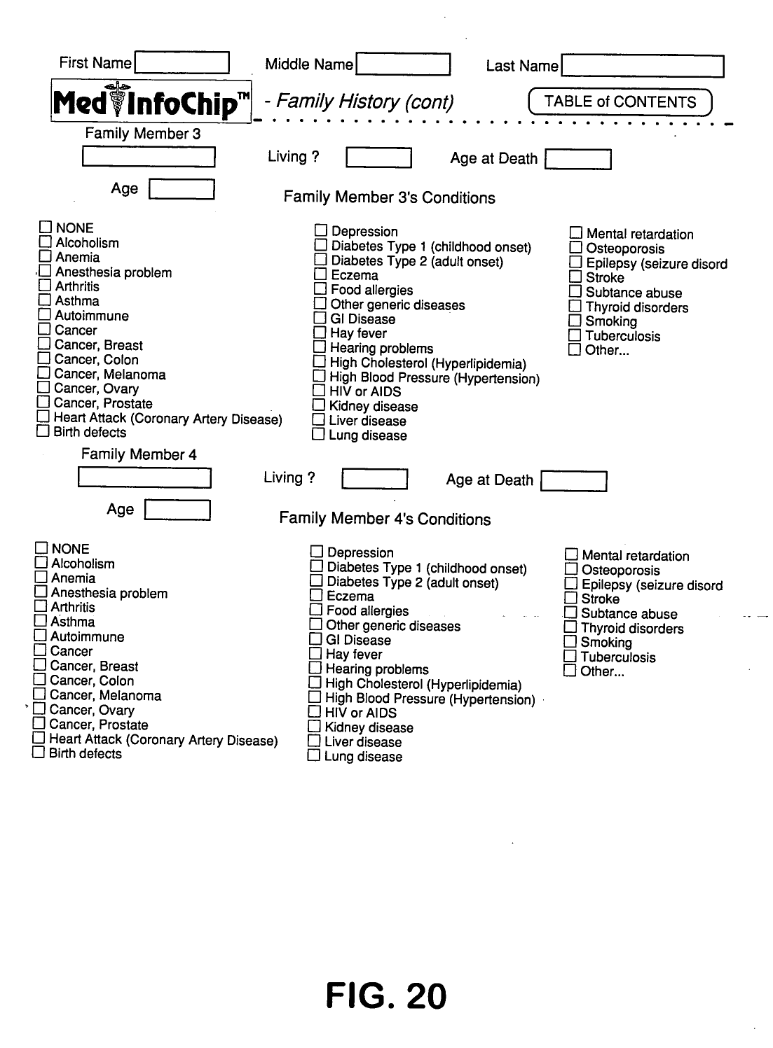

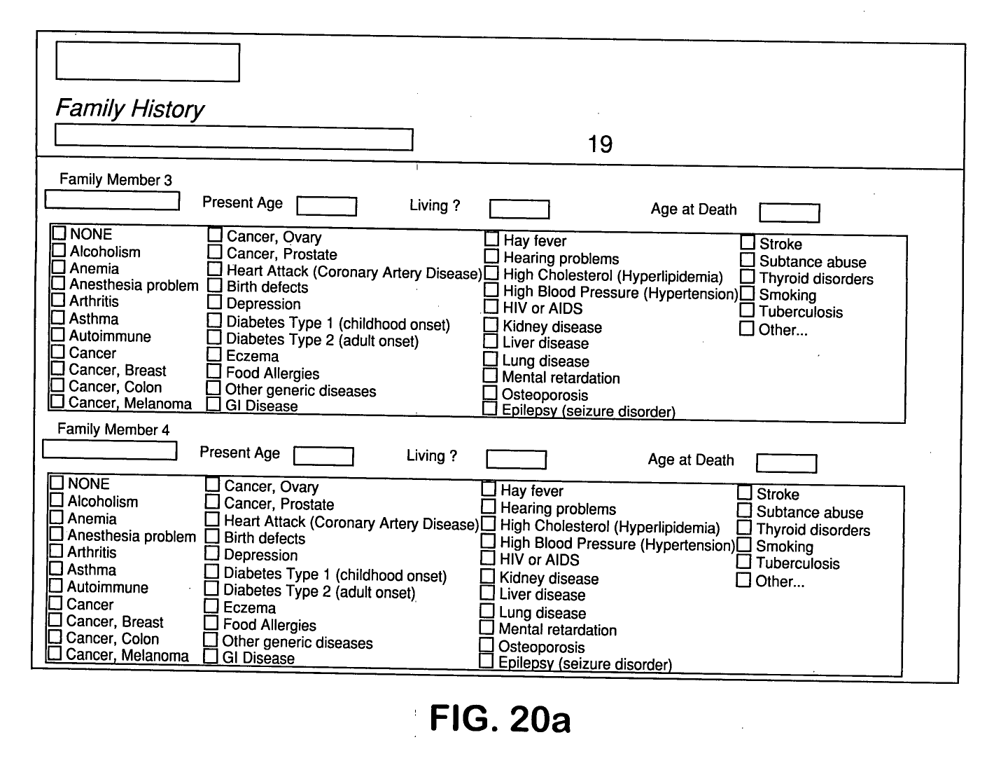

FIGS. 19 and 20 represent a first embodiment of the “Family History” fields, where the user can enter family history information. FIGS. 19a and 20a represent a second embodiment of these fields. For example, if there is a family history of heart disease, high cholesterol, high blood pressure or other condition that is typically familial, it would aid the care provider to have access to this information. Although in the embodiment shown, the user can enter information about four family members, the invention is not so limited.

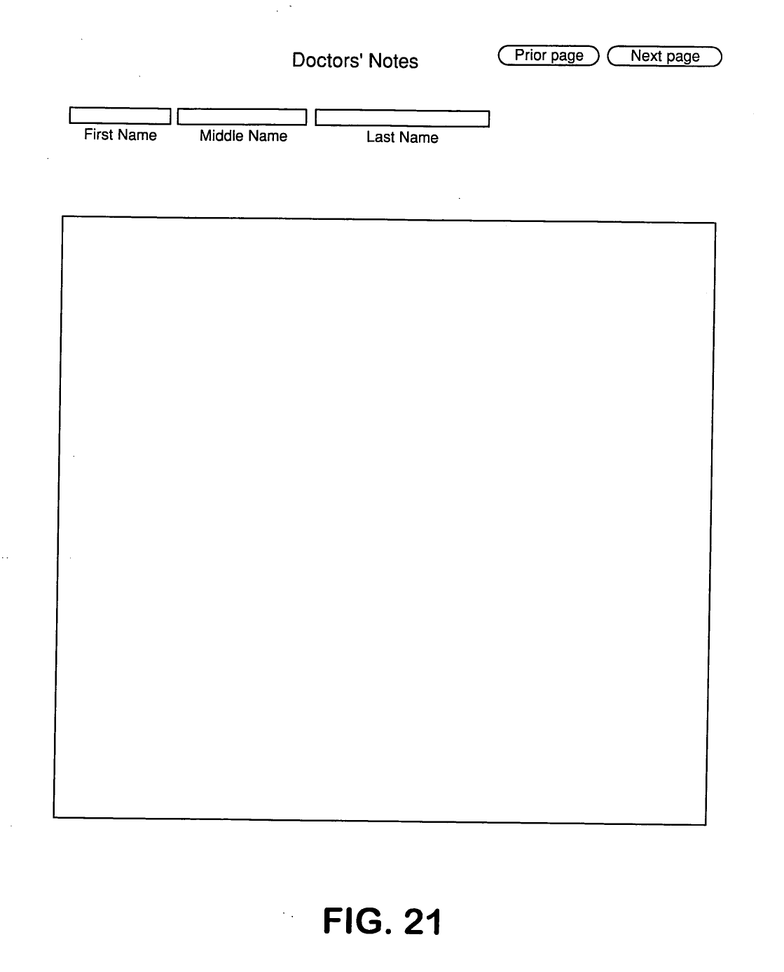

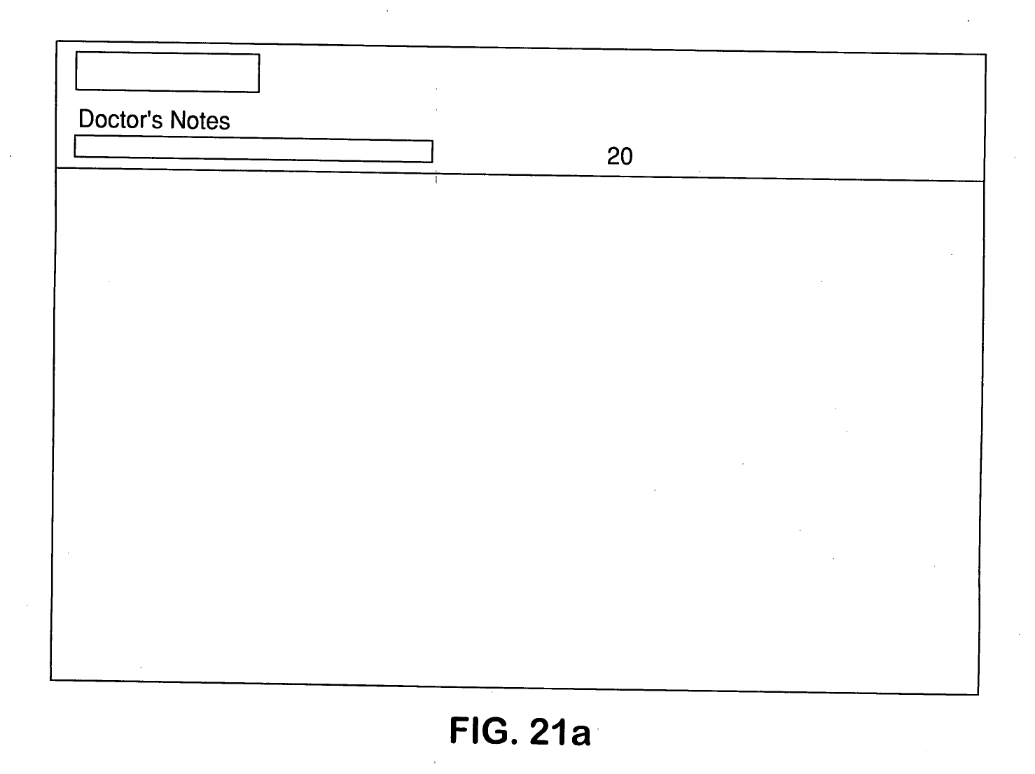

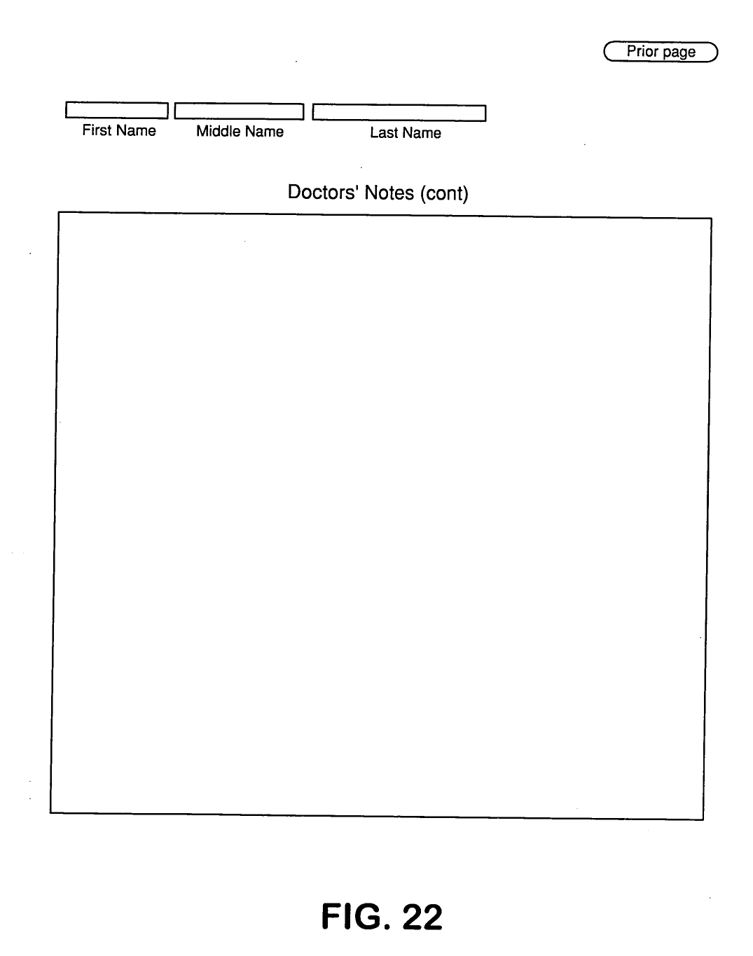

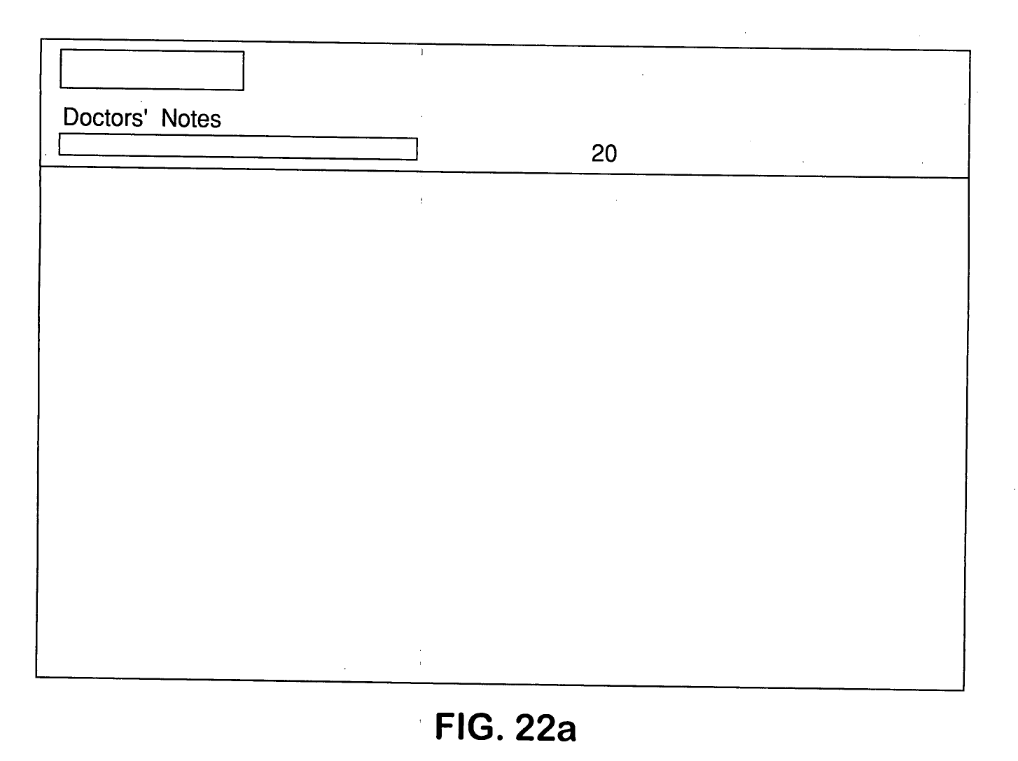

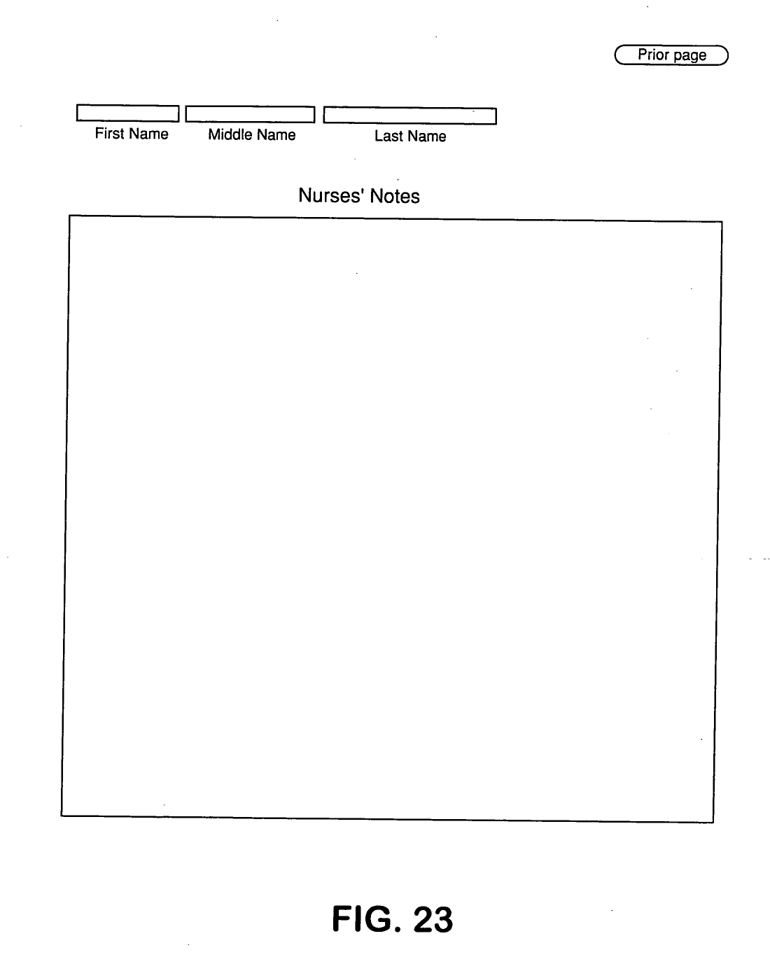

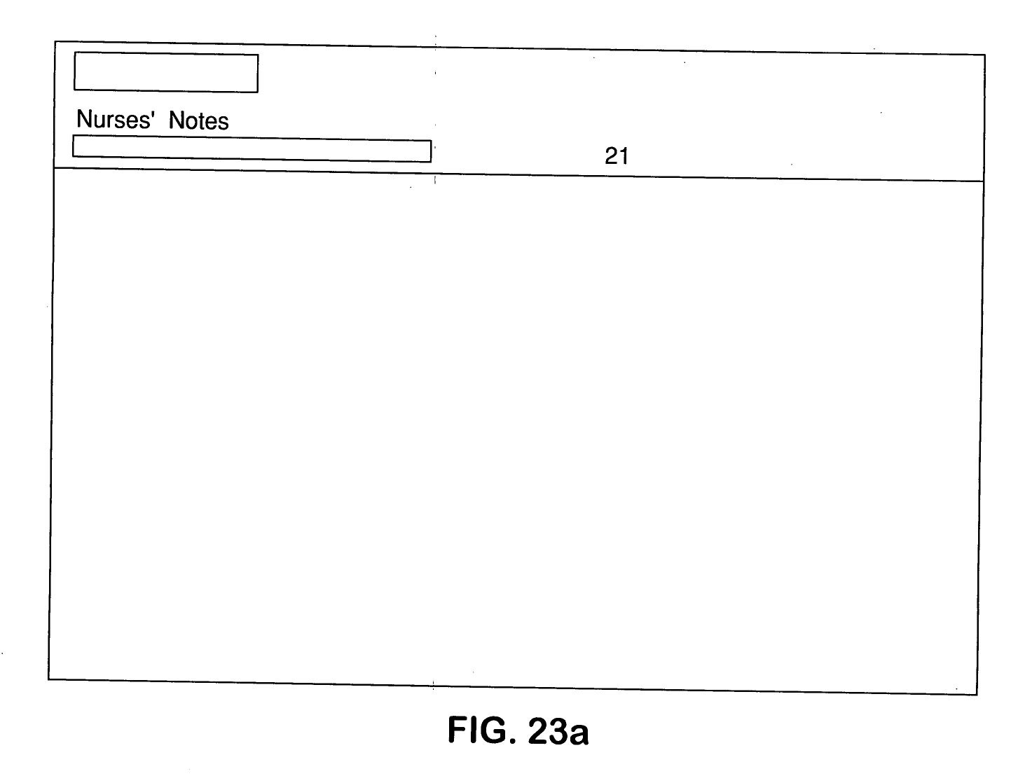

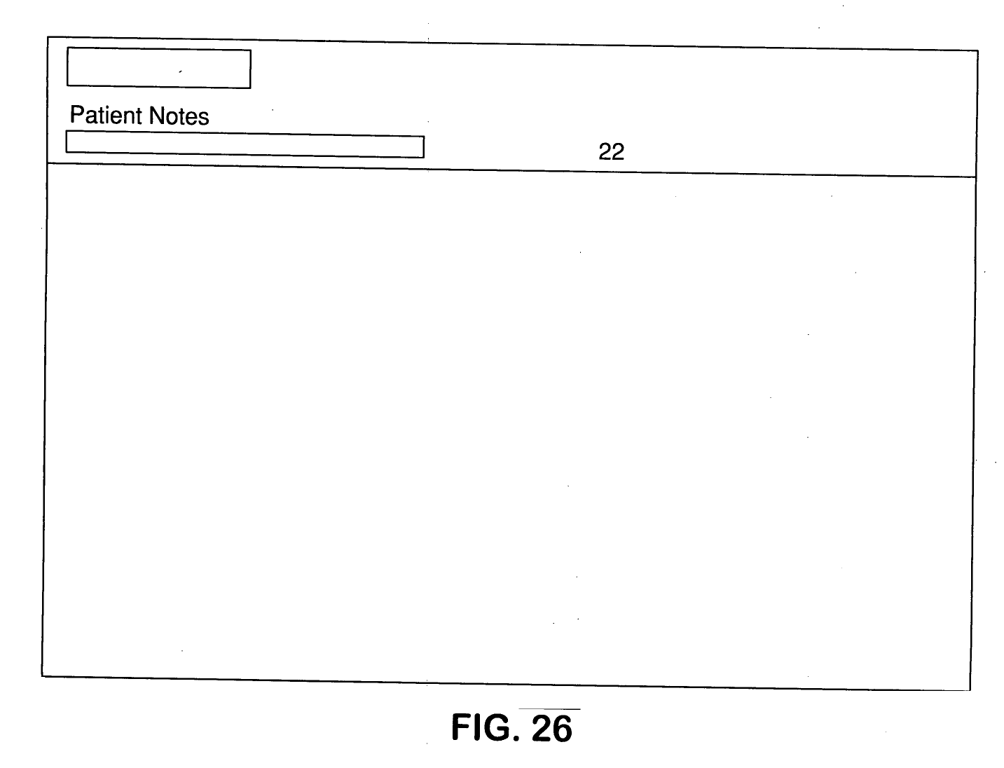

FIGS. 21 and 22 represent a first embodiment of “Doctor's Notes” fields, while FIGS. 21a and 22a represent a second embodiment of these fields. The user, or the physician, if desired, can enter text into these fields by typing in the shaded areas. Similarly, FIGS. 23 and 23a represent alternative embodiments of the “Nurses' Notes” field, where the user, or the nurse, if desired, can enter text by typing in the shaded area. FIG. 26 represents one embodiment of the “Patient's Notes”, where the user can enter text by typing in the shaded area.

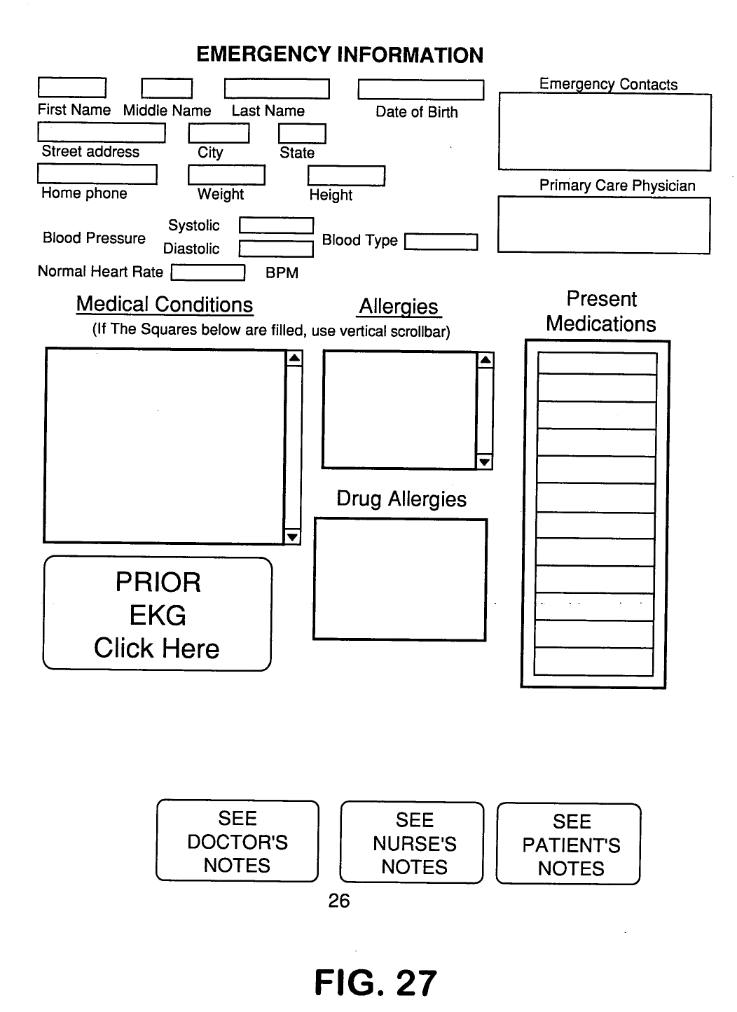

FIG. 27 represents the “Emergency Information” field. In the preferred embodiment, the software application automatically fills in the data required in this field, by utilizing data that has already been entered by the user in other fields. For example, the “present medications” section of this field is automatically filled with data that was entered by the user in FIG. 13 (or 13a). Similarly, the data associated with medical conditions, allergies, blood pressure, and drug allergies is automatically filled by the software application using data that was entered by the user in the corresponding fields. This enables the health care provider to quickly ascertain the most important medical information. In the preferred embodiment, this page is displayed immediately when the user, or health care provider “clicks” on the area on FIG. 1a, labeled “Alert Emergency Information Click Here”.

By entering the information suggested in FIGS. 1 through 23 (or alternatively, FIGS. 1a through 23a and 26), the user is able to create a complete and accurate medical history. Because the data are entered by the user, the user can decide what information to disclose and what information, if any, to withhold, thereby maintaining some level of privacy, if desired. FIGS. 1 through 23 (and

FIGS. 1a through 23a) were created through the use of a commercially available software application for database creation, known as FileMaker Pro. While this is the preferred embodiment of the invention, the invention is not limited to this embodiment. Other commercially available software applications, or specially designed software, could also be used to generate the fields used in the present invention. The use of FileMaker Pro allows the application to be used on a variety of hardware and software platforms. The present invention can be utilized on systems employing Microsoft Windows, Apple Mac or Linux. In addition, the application is available in a variety of languages to aid in its utility worldwide.

Although this disclosure describes the use of the device to store only the user's medical system, the invention is not limited to this embodiment. A second embodiment of the software application allows multiple medical histories to exist in the same device. For example, the device can contain the medical history of the user, the user's spouse, and/or the user's children.

Alternatively, the multiple medical histories can be used to provide a single user's medical profile and history in multiple languages, if that is desirous.

To aid in retrieving data stored in the device via a user interface such as a computer screen, the device optionally can be configured to include an autorun.inf file, which causes the software application to automatically execute upon insertion into the host computer. This reduces the need for the user to understand the location of the required files and improves the speed at which the information is made accessible.

In the preferred embodiment, the device contains the autorun.inf file, the FileMaker Pro application, and the fields described above. In this way, the USB connector of the device can be attached to any computer and the data is made instantly available. There is no need to load special software or applications onto the computer. Rather, all components necessary for the execution of the application and the viewing of the information are self-contained within the portable device which the user is carrying.

Other enhancements and modifications to the present invention are also contemplated.

In an alternate embodiment, the present invention contains a GPS (Global Positioning System) transmitter in addition to the storage element. This combination is particularly applicable to those patients with dementia or Alzheimer's disease. GPS transmitters are well known in the art and can be used to track assets, recover stolen cars, and other like purposes. In most applications, GPS transmitters periodically broadcast their location preferably via radio waves, typically to a satellite system. Alternatively, the GPS transmitter can be designed to continuously broadcast its position, typically upon the occurrence of a specific event. For example, the GPS transmitter used in association with the retrieval of stolen automobiles can be enabled to begin transmitting location information after the owner of the automobile has discovered that the car is missing. In most applications, the GPS transmitter has a unique identifier associated with it, thereby allowing the device to be remotely monitored. By combining the storage element of the present invention with a GPS transmitter, it is possible to create a single device that is able to locate a wayward patient and also provide all of the important medical information to allow a health care provider to successfully diagnose and treat the patient.

In another embodiment, supplemental pages can be added which contain additional information concerning specific patient conditions. For example, supplemental pages or fields can be added to provide additional information about conditions such as breast cancer, where mammograms can be included in the form of jpeg files or other formats. Similarly, supplemental pages could be added to provide information about prostrate cancer, rheumatoid arthritis, diabetes, atheroscelosis, and other ailments. These supplemental fields also allow the patient's condition to be easily and continuously monitored by including information spanning an extended period of time. For example, all of the mammograms for a given patient can be included in the supplemental pages, thus allowing health care providers to monitor and understand the progression of the ailment over time.

What is claimed:

1. A computer-readable storage medium containing a plurality of data structures and a set of instructions for a computer having a user interface, said set of instructions comprising:
an input routine operatively associated with a user interface for permitting a user to input his medical history and profile data into said plurality of data structures stored in said medium; and
a run routine for accessing said plurality of data structures containing said medical history and profile data via said user interface of said computer.

2. A method of providing information about a user comprising the steps of:
providing a portable device comprising an interface portion and a storage element, said storage element comprising a computer readable medium on which a software application and information about the user are stored;
causing said interface portion of said portable device to be in communication with a computer;
executing said software application on said computer; and
viewing said information on the display unit of said computer in a format determined by said software application.

3. The method of claim 1, whereby said software application executes automatically after said portable device is in communication with said computer.

4. The method of claim 1, whereby said information is indexed by a table of contents contained in said storage element.

5. A method of creating information about a user comprising the steps of:
providing a portable device comprising an interface portion and a storage element further comprising a computer readable medium on which a software application and information about the user are stored;
causing said interface portion of said portable device to be in communication with a computer;
executing said software application on said computer; and
inputting said information via said computer as requested by said software application.

6. The method of claim 5, whereby said information is a digital image compressed using the JPEG algorithm.

7. A method of inputting onto a portable computer-readable storage medium and accessing from said portable computer-readable storage medium the medical history of an individual, comprising the steps of:
providing a computer having a user interface;
causing said computer to communicate with said computer-readable storage medium;
inputting medical history and profile data of said individual into said portable computer-readable storage medium and storing the same therein;
interrupting said communication between said computer and said computer-readable medium;
causing said portable storage medium to communicate with a second computer having a second user interface; and
displaying said medical history and profile data via said second user interface.

8. A portable device for recording and saving the medical history of a user, comprising:
an interface adapted to communicate with a computer;
a computer-readable storage medium, in communication with said interface, further comprising:
a plurality of data structures and a set of instructions adapted to be executed on a computer having a user interface, said set of instructions comprising:
an input routine operatively associated with a user interface for permitting a user to input his medical history and profile data into said plurality of data structures stored in said medium via said computer; and
a run routine for accessing said plurality of data structures containing said medical history and profile data via said user interface of said computer.

9. The device of claim 8, further comprising a global positioning system transmitter.
